(19) United States
(12) Patent Application Publication
(10) Pub. No.: US 2025/0336151 A1
(43) Pub. Date: Oct. 30, 2025

(54) SCALABLE MULTI-MODAL PERCEPTION FRAMEWORK FOR AUTONOMOUS SYSTEMS AND APPLICATIONS

(71) Applicant: NVIDIA Corporation, Santa Clara, CA (US)

(72) Inventors: Feng Yuan, San Jose, CA (US); Kaustubh Purandare, San Jose, CA (US); Unnikrishnan Kizhakkemadam Sreekumar, San Jose, CA (US)

(21) Appl. No.: 19/077,562

(22) Filed: Mar. 12, 2025

Related U.S. Application Data
(60) Provisional application No. 63/640,750, filed on Apr. 30, 2024.

(51) Int. Cl. G06T 17/00; G06F 9/54; G06T 15/10; G06V 10/74; G06V 10/80

(52) U.S. Cl. CPC G06T 17/00; G06F 9/547; G06T 15/10; G06V 10/74; G06V 10/803; G06T 2200/08; G06T 2210/12

(57) ABSTRACT

In various examples, a framework is or provides an end-to-end solution that includes multi-sensor capture, data processing, inferencing, synchronization, alignment, and 3D rendering for multi-modal perception fusion pipelines. A multi-modal perception fusion pipeline may include a mixer, an aligner, an inference environment, and a multi-view renderer. The mixer may merge sensor data from different data sources into a single HashMap frame. The aligner may use calibration data for sensor-to-sensor coordinate transformations. The inference environment may receive multi-modality data and use custom preprocessing and custom postprocessing to generate inference results. The renderer may generate different sensor data renderings. The framework may include an application that uses configuration data to generate or configure a custom multi-modal perception fusion pipeline. The inference environment may access inference models using a uniform inference interface and support remote inference, allowing the pipeline to become an API client of the inference models.

### CROSS-REFERENCE TO RELATED APPLICATIONS

This application claims the benefit of U.S. Provisional Application No. 63/640,750 filed on Apr. 30, 2024, which is hereby incorporated by reference in its entirety.

### BACKGROUND

As computer vision systems evolve, the use of multi-modal artificial intelligence (AI) models, which can analyze data from different sensor modalities, are becoming more common. While traditional systems rely on a single sensor type and corresponding mono-modal inference models, multi-modal approaches fuse data from multiple sensors provides richer environmental cues that can improve perception. Thus, multi-modal approaches promise improved perception for applications such as autonomous driving—leading to safer navigation.

However, the integration of heterogeneous sensor data introduces significant technical challenges. Precise synchronization of time-stamped data streams and the reconciliation of varied data formats may be required to maintain high levels of inference reliability and overall system performance. Prior approaches have struggled to resolve these integration complexities in a scalable end-to-end manner. For example, current methodologies necessitate extensive hand-coding or programming of complete data pipelines to connect AI models—which exposes users to issues in performance, latency, and coding efficiency. As an example, the approaches may stich together multiple disparate frameworks and custom code, resulting in additional overhead and inefficiencies due to the need to switch between and manage different environments and frameworks.

### SUMMARY

Embodiments of the present disclosure relate to a scalable multi-modal perception framework for autonomous systems and applications. Disclosed approaches may be used to integrate diverse sensor data, such as including LiDAR, radar, and camera inputs, for multi-modal sensor fusion.

In some embodiments, the framework is or provides an end-to-end solution that includes multi-sensor capture, data processing, inferencing, synchronization, alignment, and 3D rendering. The system may be scalable to support various sensor fusion methods, such as a late fusion method (e.g., fusing 2D camera inference data and 3D LiDAR/radar inference data), and one or more multi-modal inference models. Disclosed multi-modal perception fusion pipelines may be scalable for any sensor fusion method. Separate generic components may be dynamically coupled to form a multi-modal perception fusion pipeline. For example, a multi-modal perception fusion pipeline may include a mixer, an aligner, an inference environment (e.g., including a multi-modal inference model), a multi-view renderer, and/or other modules. The mixer may merge LiDAR/radar and camera multi-frames into a single HashMap frame. The aligner may receive calibration data as input (e.g., from file) and support sensor-to-sensor coordinate transformations. The inference environment may receive multi-modality data as input and may include custom preprocessing and custom postprocessing functionalities. The renderer may generate different sensor data (e.g., LiDAR/radar, camera, etc.) renderings.

In some embodiments, the framework may include a multi-modal perception fusion application that uses configuration data to generate or configure a custom multi-modal perception fusion pipeline and to support dynamic pipeline changes (e.g., enable different components to be dynamically coupled) without coding. In some embodiments, the inference environment may access one or more multi-modal inference models. The inference environment may be built on top of a uniform inference interface such as a Cloud Function API based interface and support remote inference over HTTP/grips, allowing the pipeline to become an API client of the one or more multi-modal inference models, thus, keeping compute state simple.

### BRIEF DESCRIPTION OF THE DRAWINGS

The present systems and methods for a scalable multi-modal perception framework for autonomous systems and applications are described in detail below with reference to the attached drawing figures, wherein:

FIG. 1A illustrates an example of components of a multi-modal perception system, in accordance with some embodiments of the present disclosure;

FIG. 1B is a data flow diagram illustrating an example of a multi-modal perception pipeline that incorporates at least one multi-modal model, in accordance with some embodiments of the present disclosure;

FIG. 1C is a data flow diagram illustrating an example of a multi-modal perception pipeline that fuses multi-modal inference results, in accordance with some embodiments of the present disclosure;

FIG. 2 illustrates an example of a bridge which may be instantiated in a multi-modal perception pipeline, in accordance with some embodiments of the present disclosure;

FIG. 3 illustrates an example of a mixer which may be instantiated in a multi-modal perception pipeline, in accordance with some embodiments of the present disclosure;

FIG. 4 illustrates an example of an aligner which may be instantiated in a multi-modal perception pipeline, in accordance with some embodiments of the present disclosure;

FIG. 5 illustrates an example of an inference environment which may be instantiated in a multi-modal perception pipeline, in accordance with some embodiments of the present disclosure;

FIG. 6 illustrates an example of a renderer which may be instantiated in a multi-modal perception pipeline, in accordance with some embodiments of the present disclosure;

FIG. 7A depicts an example three-dimensional (3D) data processing pipeline, in accordance with some embodiments of the present disclosure;

FIG. 7B illustrates an example of implementing a 3D data processing pipeline with a 2D multimedia pipeline, in accordance with some embodiments of the present disclosure;

FIG. 7C is a data flow diagram illustrating an example of a multi-modal perception pipeline that incorporates LiDAR and camera data in a multi-modal perception system, in accordance with some embodiments of the present disclosure;

FIG. 7D is a data flow diagram illustrating an example of at least one multi-modal model that may be used in the multi-modal perception pipeline of FIG. 7C, in accordance with some embodiments of the present disclosure;

FIG. 7E illustrates an example of a frame that may be rendered using the multi-modal perception pipeline of FIG. 7C, in accordance with some embodiments of the present disclosure;

FIG. 8 is a flow diagram showing a method for processing data using a multi-modal perception pipeline having at least one multi-modal inference model, in accordance with some embodiments of the present disclosure;

FIG. 9 is a flow diagram showing a method for processing data using a multi-modal perception pipeline that includes late fusion of multi-modal inference data, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

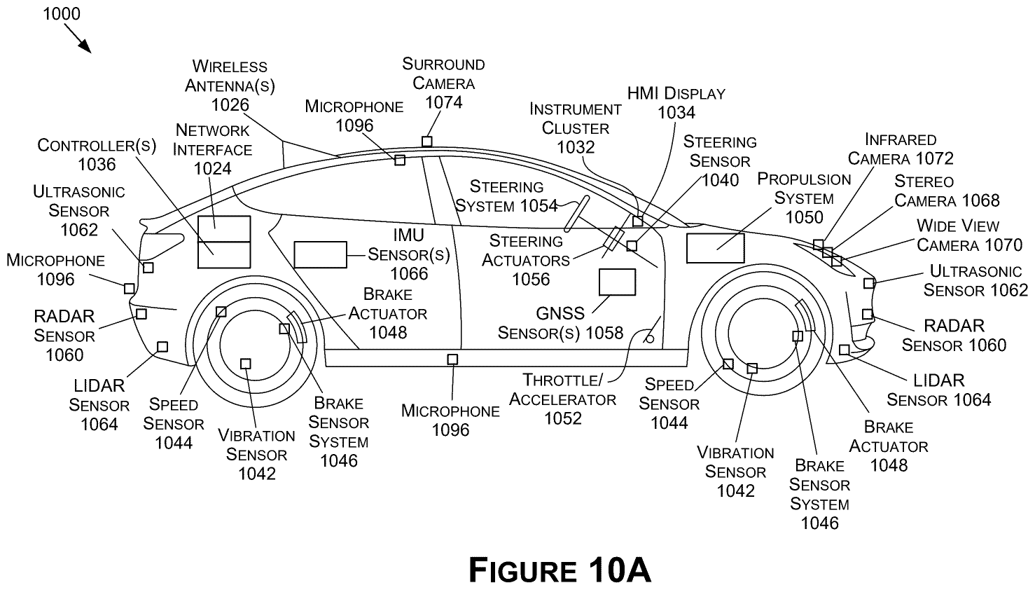

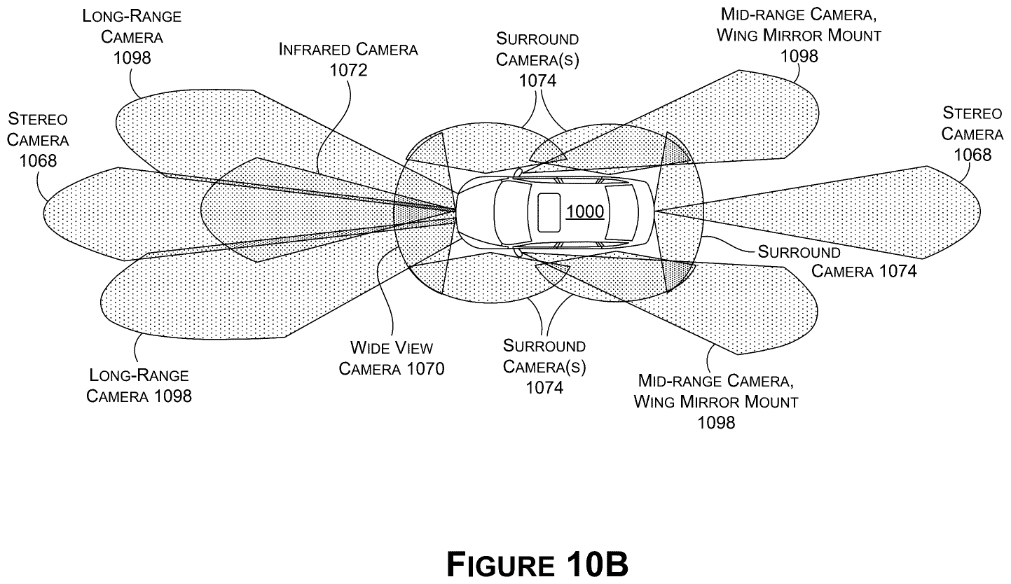

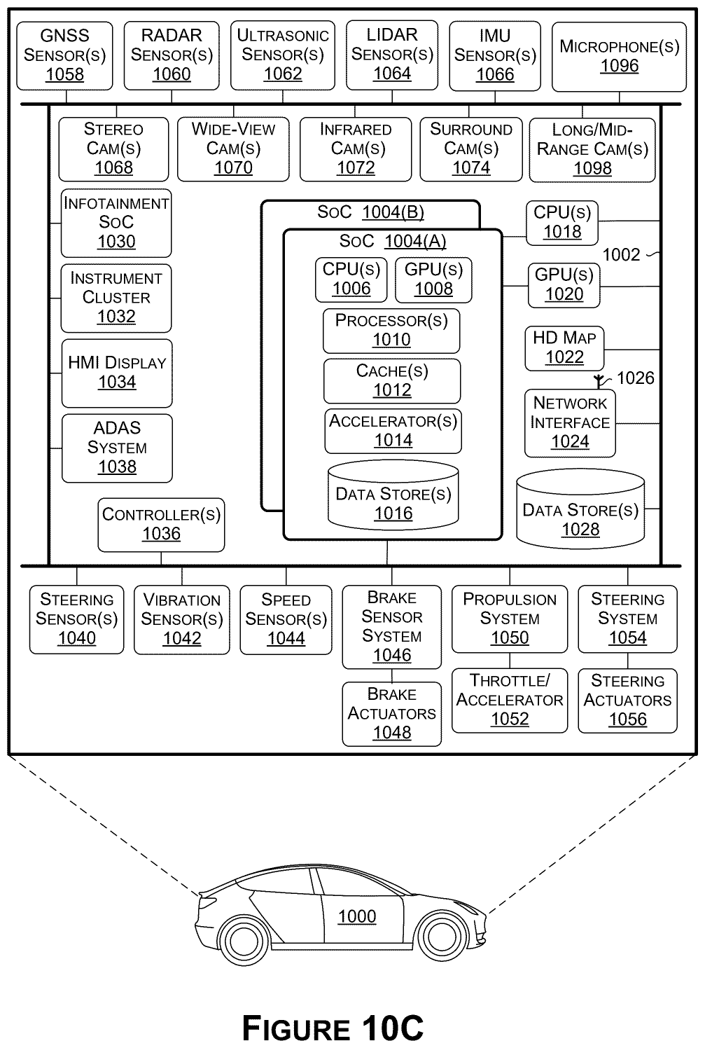

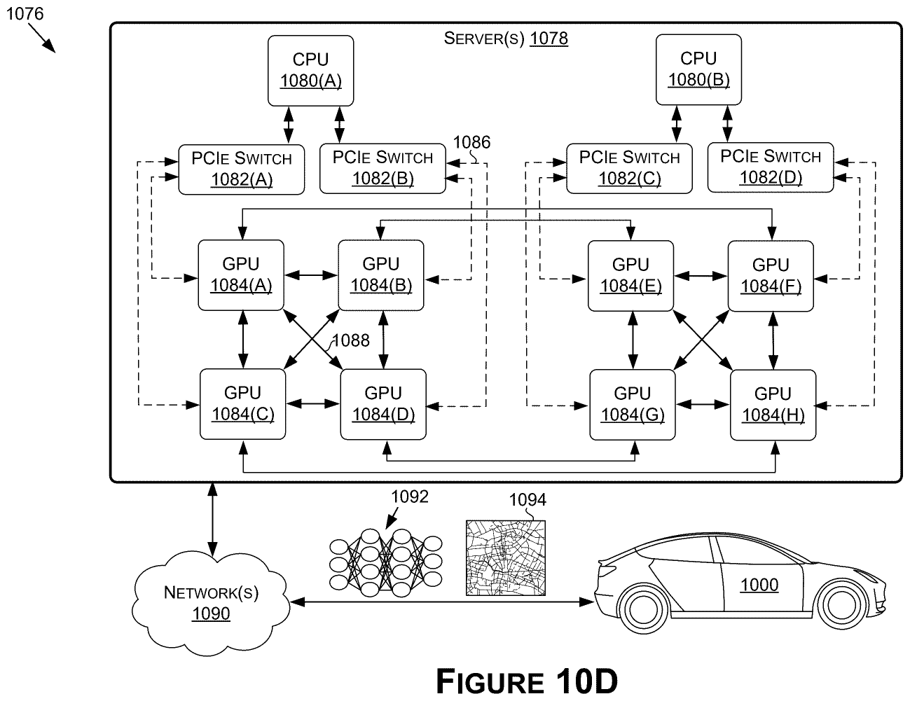

Systems and methods are disclosed related to a scalable multi-modal perception framework for autonomous systems and applications. Although the present disclosure may be described with respect to an example autonomous vehicle 1000 (alternatively referred to herein as “vehicle 1000” or “ego-vehicle 1000,” an example of which is described with respect to FIGS. 10A-10D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to data processing for autonomous (or semi-autonomous) systems and applications, this is not intended to be limiting, and the systems and methods described herein may be used in augmented reality, virtual reality, mixed reality, robotics, security and surveillance, generative AI, simulation, synthetic data generation, autonomous or semi-autonomous machine applications, transportation systems (such as traffic and/or intersection monitoring systems) and/or any other technology spaces where 2D and/or 3D data processing may be used.

Embodiments of the present disclosure relate to a scalable multi-modal perception fusion pipeline for multi-modal sensor (e.g., LiDAR/radar, camera) fusion. Systems and methods are disclosed for a scalable multi-modal perception framework for autonomous systems and applications. In some embodiments, the framework is or provides an end-to-end solution that includes multi-sensor capture, data processing, inferencing, synchronization, alignment, and 3D rendering. The system may be scalable to support various sensor fusion methods, such as a late fusion method (e.g., fusing 2D camera inference data and 3D LiDAR/radar inference data), and one or more multi-modal AI models (also referred to herein as multi-modal inference models or simply inference models. The multi-modal inference models may range in complexity and may accept video data, LiDAR/radar data and other sensor data that are fused together as input. Example multi-modal inference models include, but are not limited to, Pytorch, ONNX, Tensorflow, TRT, and Python-based models.

The multi-modal perception fusion pipeline may be scalable for any sensor fusion method. Separate generic components may be dynamically coupled to form a multi-modal perception fusion pipeline. For example, a multi-modal perception fusion pipeline may include a mixer, an aligner, an inference environment (e.g., a multi-modal inference environment), a multi-view renderer, and/or other modules. The mixer may merge LiDAR/radar and camera multi-frames into a single HashMap frame. The aligner may receive calibration data as input (e.g., from a file) and support sensor-to-sensor coordinate transformations. The inference environment may receive multi-modality data as input and may include custom preprocessing and custom postprocessing functionalities. The renderer may generate different sensor data (e.g., LiDAR/radar, camera, etc.) renderings using inference results.

In some embodiments, the framework may include a multi-modal perception fusion application that uses configuration data to generate or configure a custom multi-modal perception fusion pipeline and to support dynamic pipeline changes (e.g., enable different components to be dynamically coupled) without coding. In some embodiments, the configuration data may be received as an input (e.g., from a user interface such as graphical user interface). In some embodiments, the configuration data may comprise a single graph-based schema configuration file (e.g., a JavaScript Object Notation (JSON) file, a Tom's Obvious, Minimal Language (TOML) file, an initialization (INI) file, YAML, etc.). By providing a single configuration file rather than coding a specific pipeline application, users can efficiently and easily integrate a multi-modal inference model(s) into a multi-modal perception fusion pipeline, avoiding challenges associated with conventional techniques.

Multiple sensors (e.g., LiDAR/radar, camera, etc.) may have different framerates and timestamps during capture. In some embodiments, the mixer may synchronize different sensors based on timeclock and frame timestamps to pair (e.g., combine, mix, etc.) frames from different sensors into a single HashMap frame. The mixer module may, based on a policy(ies), drop frames, make up frames, and/or interpolate frames, to keep a pipeline operating smoothly (e.g., rendering views).

In some embodiments, the inference environment may access one or more multi-modal inference models. The inference environment may be built on top of a uniform inference interface such as a Cloud Function API based interface. The inference environment may support remote inference over HTTP/gRPC, allowing the inference environment or, generally the pipeline, to become an API client of the one or more inference models, thus, keeping compute state simple. An inference model may be deployed on a remote cloud (which could have powerful GPUs) or a separate local container (e.g., NVCF model containers or a Triton inference server from NVIDIA Corporation). In at least one embodiment, buffer-sharing technology (e.g., CUDA-IPC, CPU-based shared memory across containers, and/or multi-processes) may be used for local containers to improve buffer efficiency and performance for real-time compute.

In some embodiments, the renderer provides a rendering corresponding to multi-sensor data from the multiple sensors. In one or more embodiments, the renderer is capable of supporting multiple, different views (e.g., single LiDAR/radar data displayed into a top view and front view together) for one or more (e.g., each) sensors.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for performing generative AI operations, systems implemented using one or more language models—such as large language models (LLMs), small language models (SLMs), multi-modal language models (MMLS), or vision language models (VLMs), systems implemented at least partially in a data center, systems for performing conversational AI operations, systems for performing light transport simulation, systems for performing collaborative content creation for 3D assets, systems implemented at least partially using cloud computing resources, and/or other types of systems.

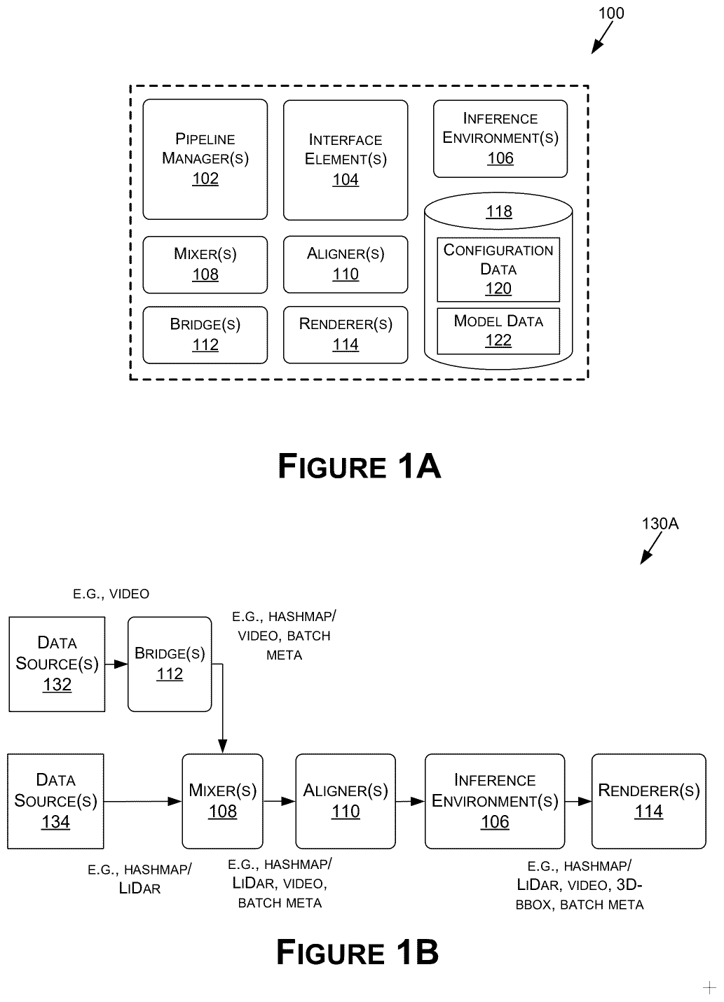

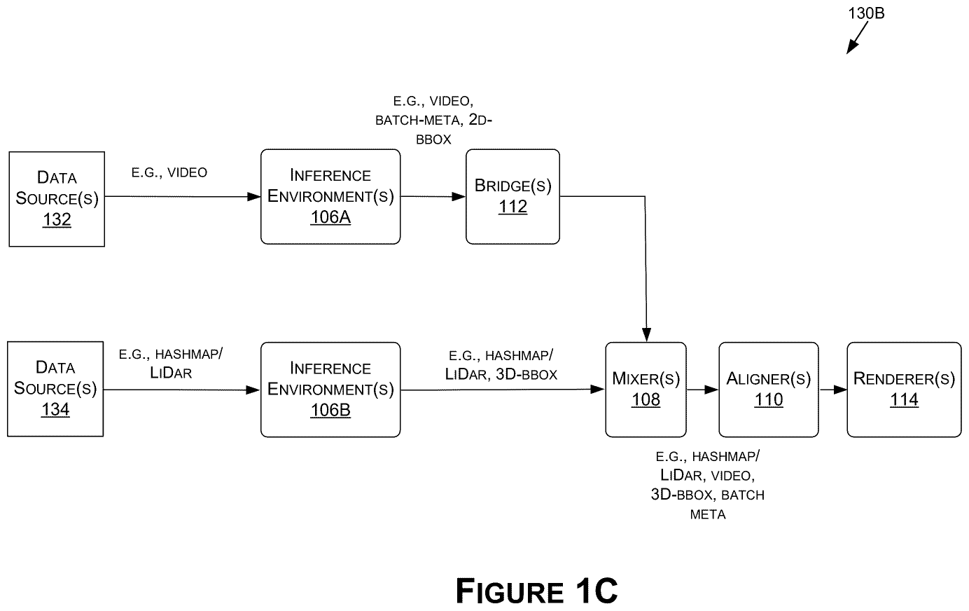

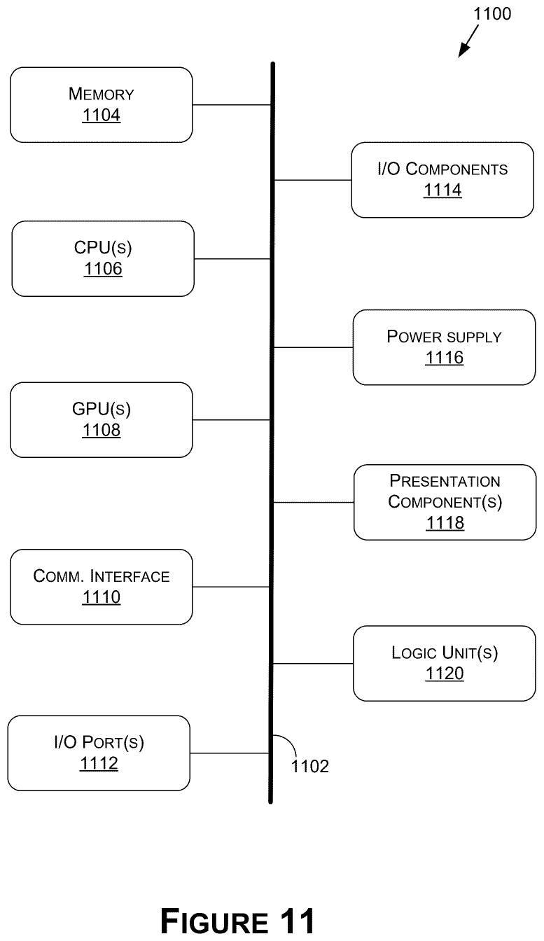

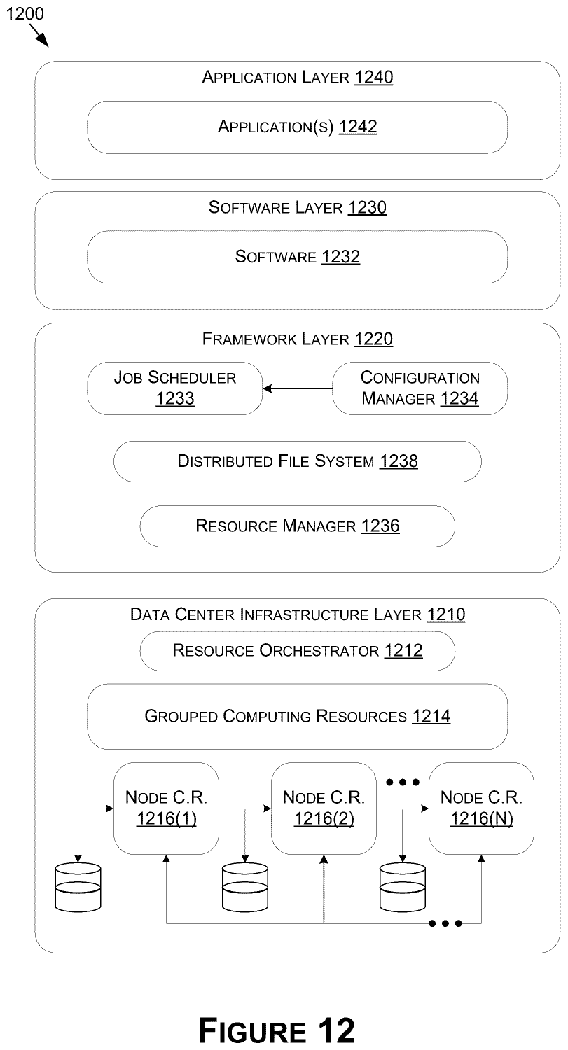

With reference to FIG. 1A, FIG. 1A illustrates an example of components of a multi-modal perception system 100 (perception system 100), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

In some embodiments, features, functionality, and/or components of the perception system 100 may be similar to those of computing device 1100 of FIG. 11 and/or the data center 1200 of FIG. 12. In one or more embodiments, the perception system 100 may correspond to simulation applications, and the methods described herein may be executed by one or more servers to render graphical output for simulation applications, such as those used for testing and validating autonomous navigation machines or applications, or for content generation applications including animation and computer-aided design. The graphical output produced may be streamed or otherwise transmitted to one or more client device, including, for example and without limitation, client devices used in simulation applications such as: one or more software components in the loop, one or more hardware components in the loop (HIL), one or more platform components in the loop (PIL), one or more systems in the loop (SIL), or any combinations thereof.

The perception system 100 may include, among other components, a pipeline manager 102, an interface element(s) 104, an inference environment(s) 106, a mixer(s) 108, an aligner(s) 110, a bridge(s) 112, a renderer(s) 114, and a data store 118. The data store 118 may store, amongst other information, configuration data 120 and model data 122.

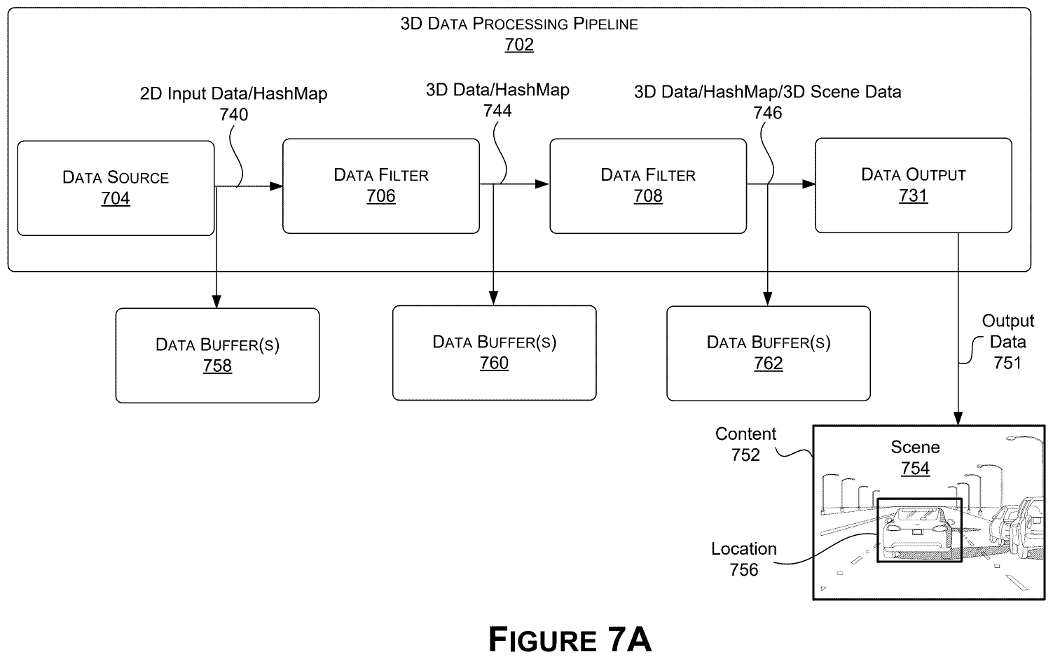

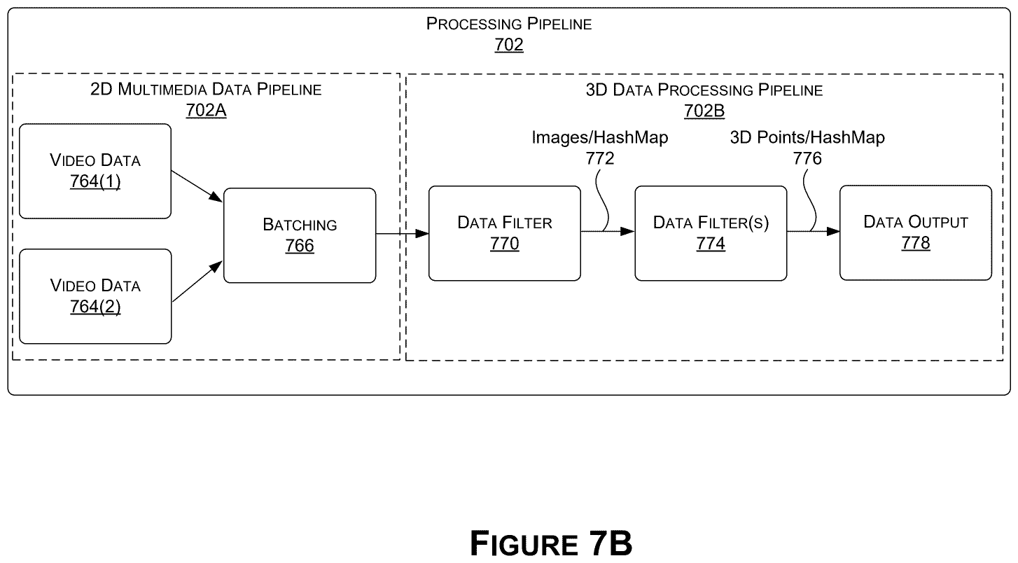

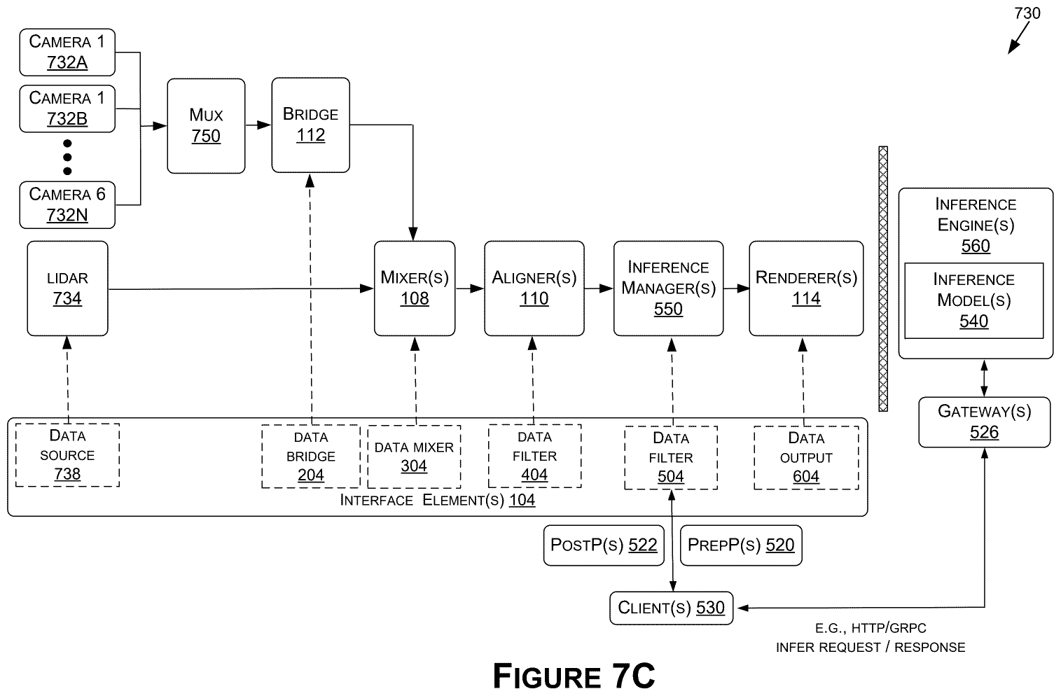

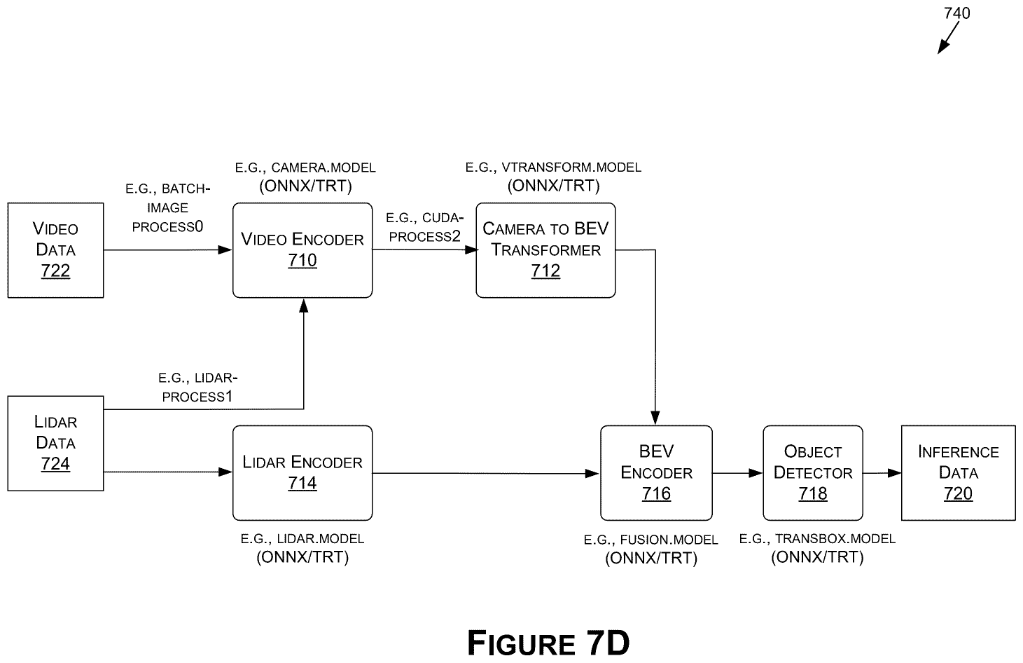

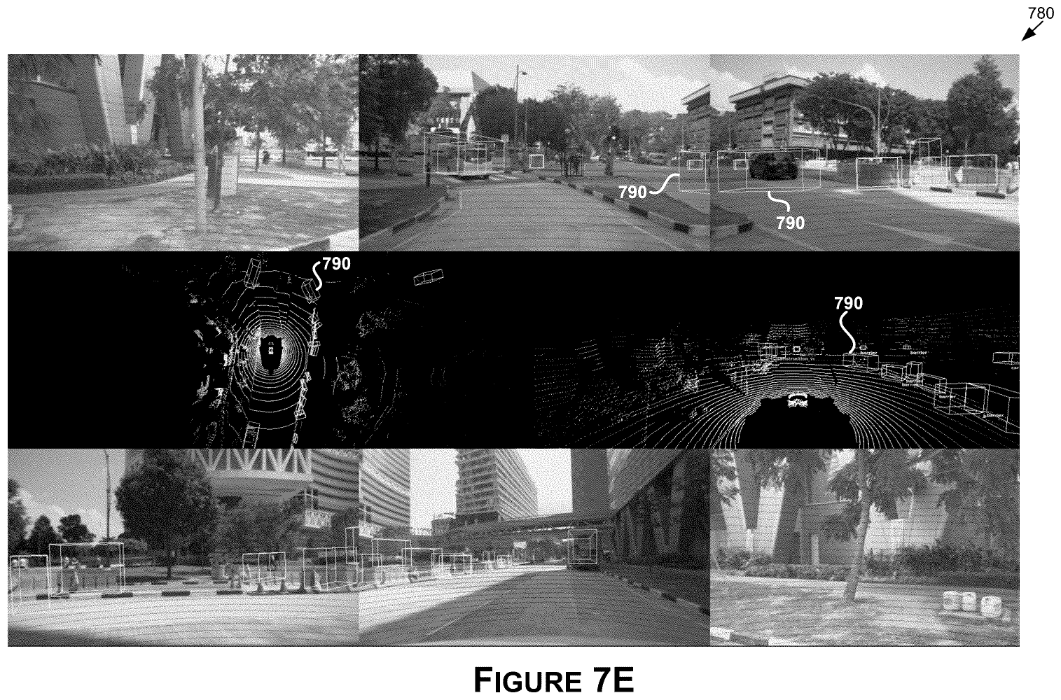

As an overview, the pipeline manager 102 may be configured to set up and manage inferencing pipelines, such as a multi-modal perception pipeline 130A of FIG. 1B, a multi-modal perception pipeline 130B of FIG. 1C, and/or a multi-modal perception pipeline 702 of FIG. 7A according to the configuration data 120. The inference environment(s) 106 may include software and/or hardware for hosting and managing one or more inference models, where an inference engine may be employed to execute the model(s), transform input data into actionable predictions, and orchestrate the overall inference workflow. The interface element(s) 104 may be configured as foundational, abstract modules from which specific pipeline components—such as the bridge(s) 112, the mixer(s) 108, the aligner(s) 110, and the renderer(s) 114—are instantiated. The interface element(s) 104 may define standardized communication protocols and operational interfaces, ensuring consistent data exchange and interoperability across the various stages of the multi-modal perception pipeline.

The bridge(s) 112 may be configured to convert input data that corresponds to one or more first branches and/or sub-pipelines of a multi-modal perception pipeline into a format (e.g., a unified data structure format, such as a HashMap) that is compatible with one or more second branches and/or sub-pipelines of the multi-modal perception pipeline. The mixer(s) 108 may be configured to receive input data from one or more branches and/or sub-pipelines of a multi-modal perception pipeline and synchronize and/or merge the data into a consolidated format (e.g., a combined HashMap) that represents the integrated information from various sensor modalities. The aligner(s) 110 may be configured to perform spatial and/or coordinate alignment on input data corresponding to multiple branches and/or sub-pipelines of a multi-modal perception pipeline (e.g., sensor data or corresponding inference results) to facilitate accurate rendering and/or subsequent analysis. The renderer(s) 114 may be configured to generate renderings corresponding to inference results from the multi-modal perception pipeline, which may include multiple views corresponding to multiple sensor data sources with overlays.

In at least one embodiment, one or more components of the perception system 100 may be implemented, at least in part, using a multi-modal sensor fusion framework that integrates heterogeneous sensor data-such as two-dimensional (2D) video from cameras and/or three-dimensional (3D) point clouds from LiDAR and/or RADAR-into a unified processing pipeline. In at least one embodiment, the framework may comprise a software architecture that provides a standardized environment for constructing, configuring, and dynamically managing multi-modal sensor fusion pipelines. The framework may comprise modular components, such as those shown in the perception system 100, each configured to perform a specific function.

In at least one embodiment, the configuration data 120 includes a graph-based description of a multi-sensor perception pipeline that identifies components of the pipeline and interconnection specifications corresponding to two or more of the components. The configuration data 120 for a pipeline may be provided via a single schema configuration file—such as a JavaScript Object Notation (JSON) file, a Tom's Obvious, Minimal Language (TOML) file, an initialization (INI) file, or a Yet Another Markup Language (YAML) file—that defines the individual processing components and the interconnections among them.

The pipeline manager 102 may be implemented, at least in part, as an application that receives the configuration file as an input. The application may parse the graph-based schema configuration file to identify components (or modules) and their interconnection specifications to dynamically generate the pipeline. For example, the application may instantiate and/or configure instances of the specified components and communication channels, which may be implemented, for example, using HashMap buffers between the various components. By providing for use of a configuration file rather than requiring coding a specific pipeline application, users can efficiently and easily integrate a multi-modal inference model(s) into a multi-modal perception fusion pipeline, avoiding challenges associated with conventional techniques.

In at least one embodiment, the framework is implemented, at least in part, as a dynamic, modular pipeline orchestration system. Each module (e.g., corresponding to an interface element 104) may be developed as an independent plugin (e.g., data source plugin, data filter plugin, data output plugin, etc.) adhering to a well-defined interface, enabling dynamic discovery and instantiation at runtime. Using a plugin-based approach may allow for each component—ranging from sensor data loaders, data bridges, mixers, and filters to inference modules and renderers—to be independently configured and optimized.

By using graph-based configuration data for pipeline generation, embodiments of present frameworks may streamline the development and integration of complex multi-modal sensor fusion applications—offering an efficient, adaptable, and scalable solution for advanced perception systems. Further, disclosed approaches may provide for frameworks that support dynamic pipeline reconfiguration (e.g., without coding). For example, the pipeline manager 102 may be capable of enabling different components to be coupled or decoupled on-the-fly through updates to the configuration data 120 and/or dynamically through updates to a deployed pipeline based on real-time inputs or external configuration data received from interfaces such as a graphical user interface. This dynamic and modular reconfiguration capability may permit the perception system 100 to adapt to various sensor setups and fusion models—such as BEVFusion, BEVHeight, or late fusion pipelines—thereby facilitating scalable and flexible integration of multi-modal inference models without manual code modifications.

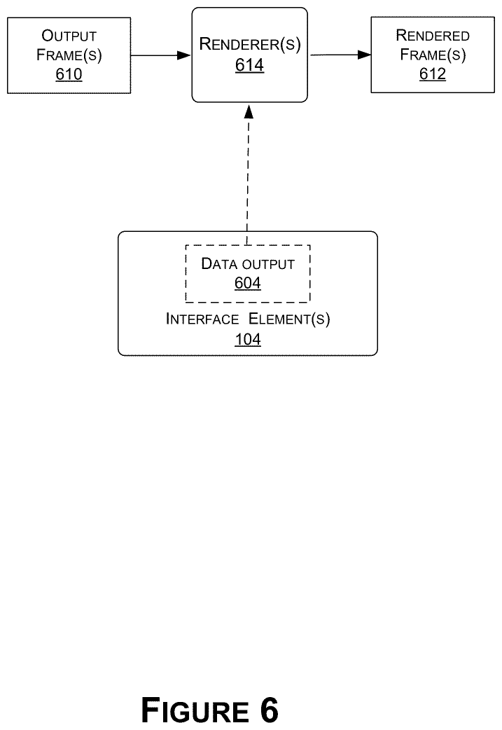

FIGS. 1B, 1C, and 6A depict example multi-modal perception fusion pipelines that may be created using the configuration data 120 as input to a multi-modal perception fusion application. Referring now to FIG. 1B, FIG. 1B is a data flow diagram illustrating an example of a multi-modal perception pipeline 130A that incorporates at least one multi-modal model, in accordance with some embodiments of the present disclosure. The multi-modal perception pipeline 130A may include additional components not shown in FIG. 1B. The multi-modal perception pipeline 130A includes a data source(s) 132 and a data source(s) 134 which may correspond to multiple sensor modalities and/or sensors. For example, the data source(s) 132 may provide one or more streams and/or frames of 2D sensor data, such as video data, and the data source(s) 134 may provide one or more streams and/or frames of 3D sensor data, such as LiDAR and/or RADAR data.

The bridge(s) 112 may receive sensor data corresponding to the data source(s) 132 and may convert the sensor data into a format (e.g., a unified data structure format, such as a HashMap) that is compatible with sensor data corresponding to the sensor data from the data source(s) 134. The mixer(s) 108 may receive the sensor data corresponding the data source(s) 134 and the converted sensor data provided by the bridge(s) 112 and may synchronize and/or merge the sensor data into a consolidated format (e.g., a combined HashMap) that represents the integrated sensor data from various sensor modalities. For example, the mixer(s) 108 may synchronize one or more frames of sensor data corresponding to the data source(s) 132 and one or more frames of sensor data corresponding to the data source(s) 134 into one or more synchronized frames of the sensor data (e.g., that separately capture the sensor data and/or data points from the multiple-modalities, data sources, and/or sensors).

The aligner(s) 110 may receive the synchronized sensor data and may perform spatial and/or coordinate alignment on the sensor data across sensor modalities and/or sensors. The inference environment(s) 106 may receive the aligned sensor data, apply the sensor data one or more multi-modal inference models, and may generate, based on the application of the sensor data to the one or more multi-modal inference models, fused prediction or inference results corresponding to the aligned sensor data. The renderer(s) 114 may receive the inference results from the inference environment(s) 106 and may generate one or more renderings corresponding to the inference results, which may include, for example, one or more views representing one or more frames of sensor data from the data source(s) 132 and/or one or more views representing one or more frames of sensor data from the data source(s) 134. In at least one embodiment, the multi-modal perception pipeline 130A may include additional branches, sub-pipelines, and/or components than what is shown in FIG. 1B, which may include one or more additional bridges 112, mixers 108, aligners 110, inference environments 106, and/or renderers 114.

In at least one embodiment, the pipeline 130A includes a 2D multimedia decoder pipeline (e.g., feeding into the bridge 112) and 3D data processing components or modules. The 2D multimedia decoder pipeline may be command line-based pipeline such as a gstreamer pipeline or a ffmpeg pipeline. The 3D data processing components may include the bridge 112, the mixer 108, the aligner 110, the inference environment 106, and the renderer 114, as described above. The pipeline 130A may fuse input data (e.g., 2D camera data and 3D LiDAR/radar data) of an environment to generate a multi-view of the environment, wherein the multi-view of the environment may include bounding box data, segmentation data, classification data, etc., for one or more views of the multi-view.

Below is an example of a portion of multi-modal perception graph-based configuration data 120 for implementing the pipeline 130A of FIG. 1B. Each module of the pipeline 130A of FIG. 1B may be specified using the attributes or parameters shown. For example, each module or component may be specified in the configuration file using one or more of a name attribute, a type attribute, a caps attribute, a lib_path attribute, a config_body attribute, a link_to attribute, and a sub-pipeline attribute. Other attributes are contemplated:

name: component_unique_name
type: datasource/datafilter/datamixer/dataoutput/sub-pipeline
link_to: next_component_name
in/out caps: [hashmap, video]
lib_path: liblidar_capture.so
config_body:
custom_xxx:

Descriptions of the attributes above are provided below:
name: user define unique name for this component
type: specify the component type in the graph
caps: components in/out capability type.
lib_path: specify the lib path where to load it as datasource/datafilter/datamixer/dataoutput
config_body: the lib will parse the content for its own 3D processing
link_to: links to the next component sub-pipeline: this is for 2D multimedia pipelines (such as gstreamer or ffmpeg)

Below is an example of another portion of the multi-modal perception graph-based configuration data 120 for implementing the pipeline 130A of FIG. 1B, and in particular a portion of an example YAML configuration file for a “graph” of a camera source to the bridge 112 to the mixer 108 of FIG. 1B, and a “graph” of a LiDAR data source 134 to the mixer 108 to the aligner 110 of FIG. 1B:

```
# [subpipeline: uridecodebin −> videoconvert −> nvstreammux ] −> bridge −> mixer
  name: video_source
  type: sub-pipeline
  link_to: bridge
  config_body:
    parse_bin: uridecodebin uri=file:///path/to/camera.mp4 ! nvvideoconvert !
  nvstreammux name=m width=1280 height=720 batch-size=1
  ---
  name: bridge
  type: datafilter
  link_to: mixer
  in_caps: video
  out_caps: hashmap
  lib_path: lib2d_to_3d_databridge.so
  config_body:
    surface_to_tensor: True
  ---
# lidar_capture −> mixer −> alignment
  name: lidar_capture
  type: datasource
  link_to: mixer
  out_caps: hashmap
  lib_path: liblidar_capture.so
  config_body:
    data_path: lidar_data.bin
  ---
  name: mixer
  type: datamixer
  link_to: alignment
  in_caps: hashmap
  out_caps: hashmap
  lib_path: libmixer.so
  config_body:
    timeout: 1000
```

Below is a further example of another portion of the multi-modal perception graph-based configuration data 120 for implementing the pipeline 130A of FIG. 1B:

```
# alignment −> multi-modal-inference −> multi-view-render
  name: alignment
  type: datafilter
  link_to: multi-modal-inference
  in_caps: hashmap
  out_caps: hashmap
  lib_path: libalignment.so
  config_body:
    cam_intrinsic: [...]
    lidar_to_cam_extrinsic: [...]
  ---
  name: multi-modal-inference
  type: datafilter
  link_to: multi-view-render
  in_caps: hashmap
  lib_path: libmulti_modal_inference.so
  config_body:
    model_inputs:
    model_outputs:
  ---
  name: multi-view-render
  type: dataoutput
  in_caps: hashmap
  lib_path: libmulti_view_render.so
  config_body:
    - 2d_view: # image view
    - 3d_top_view: # lidar top view
    - 3d_front_view: # lidar front view
```

Referring now to FIG. 1C, FIG. 1C is a data flow diagram illustrating an example of a multi-modal perception pipeline 130B that fuses multi-modal inference results, in accordance with some embodiments of the present disclosure. The multi-modal perception pipeline 130B may include additional components not shown in FIG. 1C. The multi-modal perception pipeline 130B includes the data source(s) 132 and the data source(s) 134 which may correspond to multiple sensor modalities and/or sensors. For example, the data source(s) 132 may provide one or more streams and/or frames of 2D sensor data, such as video data and the data source(s) 134 may provide one or more streams and/or frames of 3D sensor data, such as LiDAR and/or RADAR data.

An inference environment(s) 106A may receive the sensor data corresponding to the data source(s) 132, apply the sensor data one or more inference models (e.g., one or more mono-modal inference models), and may generate, based on the application of the sensor data to the one or more inference models, prediction or inference results corresponding to the sensor data (e.g., mono-modal inference results). In at least one embodiment, the inference environment(s) 106A corresponds to an example of an inference environment 106 of FIG. 1A.

Similarly, an inference environment(s) 106B may receive the sensor data corresponding to the data source(s) 134, apply the sensor data one or more inference models (e.g., one or more mono-modal inference models), and may generate, based on the application of the sensor data to the one or more inference models, prediction or inference results corresponding to the sensor data (e.g., mono-modal inference results). In at least one embodiment, the inference environment(s) 106B corresponds to an example of an inference environment 106 of FIG. 1A.

The bridge(s) 112 may receive the inference results corresponding to the data source(s) 132 and may convert the inference results into a format (e.g., a unified data structure format, such as a HashMap) that is compatible with the inference results corresponding to the sensor data from the data source(s) 134. The mixer(s) 108 may receive the inference results corresponding the data source(s) 134 and the converted inference results provided by the bridge(s) 112 and may synchronize and/or merge the inference results into a consolidated format (e.g., a combined HashMap) that represents the integrated inference results from various sensor modalities. For example, the mixer(s) 108 may synchronize one or more frames of inference results corresponding to the data source(s) 132 and one or more frames of inference results corresponding to the data source(s) 134 into one or more synchronized frames of the inference results (e.g., that separately capture the inference results from the multiple-modalities, data sources, and/or sensors).

The aligner(s) 110 may receive the synchronized inference results and may perform spatial and/or coordinate alignment on the inference results across sensor modalities and/or sensors, for example, to generate fused and/or aligned inference results. The renderer(s) 114 may receive the inference results from the aligner(s) 110 and may generate one or more renderings corresponding to the inference results, which may include, for example, one or more views representing one or more frames of sensor data from the data source(s) 132 and/or one or more views representing one or more frames of sensor data from the data source(s) 134. In at least one embodiment, the multi-modal perception pipeline 130B may include additional branches, sub-pipelines, and/or components than what is shown in FIG. 1C, which may include one or more additional bridges 112, mixers 108, aligners 110, inference environments 106, and/or renderers 114. Further, in at least one embodiment, a multi-modal perception pipeline generated using the configuration data 120 may include a combination of features and/or components from the multi-modal perception pipeline 130A and the multi-modal perception pipeline 130B (e.g., both one or more mono-modal inference models, one or more multi-modal inference models, and/or late fusion).

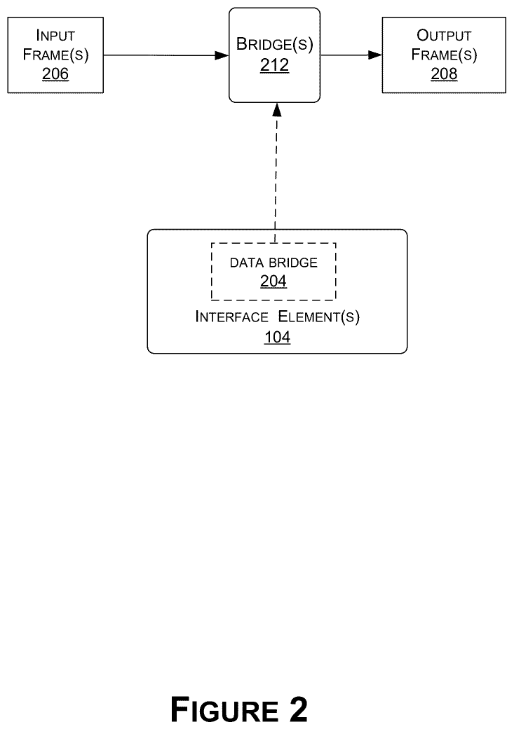

Referring now to FIG. 2, FIG. 2 illustrates an example of a bridge(s) 212 which may be instantiated in a multi-modal perception pipeline, in accordance with some embodiments of the present disclosure. In at least one embodiment, the bridge(s) 212 corresponds to the bridge(s) 112 in one or more of FIGS. 1A-1C.

The bridge(s) 212 may be configured to convert input data, such as an input frame(s) 206 that corresponds to one or more first branches and/or sub-pipelines of a multi-modal perception pipeline into output data, such as an output frame(s) 208 having a format (e.g., a unified data structure format, such as a HashMap) that is compatible with one or more second branches and/or sub-pipelines of the multi-modal perception pipeline. As indicated in FIGS. 1B and 1C, the input frame(s) 206 may represent or include one or more frames of sensor data and/or inference results or data. In at least one embodiment, the bridge(s) 212 couples a 2D pipeline with a 3D pipeline. For example, video data and/or corresponding inference results from one or more camera sources may be combined or otherwise processed (e.g., into a specific format) as input into the bridge(s) 212. By way of example, the video data may be processed using mono-sensor data custom processing components of a pipeline, which may be specified in the configuration data 120.

In at least one embodiment, the bridge(s) 212 may translate sensor-specific data into a common data structure, such as a HashMap or data map that may be based on key-value pairs and is suitable for subsequent processing with data from another branch or sub-pipeline. In at least one embodiment, the bridge(s) 212 may wrap video memory (e.g., raw sensor data and corresponding metadata) into the common data structure. In some embodiments, a bridge(s) 212 may not be required. For example, a LiDAR, RADAR, or other sub-pipeline may include one or more data loader components (e.g., dedicated acquisition components) to acquire and format corresponding data directly into the common data structure format. As an example, a dedicated LiDAR data loaders may capture LiDAR point cloud data and convert the captured data into the format-without the need for additional conversion.

In at least one embodiment, the bridge(s) 212 is derived from a data bridge 204 of the interface elements 104. The data bridge 204 may define a standardized contract for converting sensor-specific data into the unified data structure. For example, the data bridge 204 may provide a set of predefined methods and data structures that are responsible for data conversion, metadata embedding, memory and resource management, and/or standardized interface. Data conversion may include functions that extract raw input—such as video buffers and associated pre-processing metadata—and convert them into a tensor-based format encapsulated within a data map. Metadata embedding may include functions for embedding key-value pairs and other contextual metadata into the unified data structure, ensuring that all relevant sensor information may be preserved throughout the pipeline. Memory and resource management may include function that handle memory allocation, buffer management, and error handling during the conversion process, for example, to ensure data is correctly formatted and available for subsequent processing stages. By conforming to the interface of the data bridge 204, the bridge(s) 212 may be ensured to have interoperability with other components of the multi-modal perception pipeline.

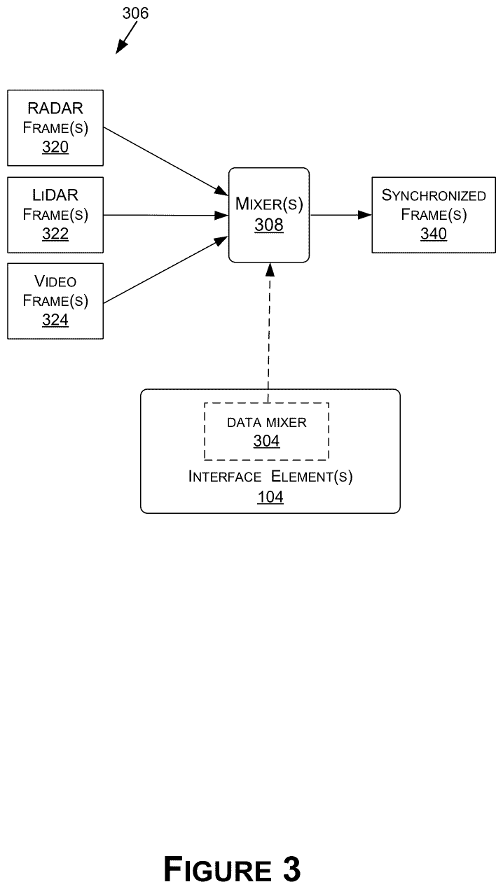

Referring now to FIG. 3, FIG. 3 illustrates an example of a mixer(s) 308 which may be instantiated in a multi-modal perception pipeline, in accordance with some embodiments of the present disclosure. In at least one embodiment, the mixer(s) 308 corresponds to the mixer(s) 108 in one or more of FIGS. 1A-1C.

The mixer(s) 308 may be configured to synchronize and/or merge input data, such as input frames 306 that corresponds to one or more first branches and/or sub-pipelines of a multi-modal perception pipeline to form output data, such as one or more synchronized frames 340 having a format (e.g., the unified data structure format, such as a HashMap) that is compatible with one or more second branches and/or sub-pipelines of the multi-modal perception pipeline. The synchronized frame(s) 340 may represent integrated information from various sensor modalities. For example, the synchronized frame(s) 340 may correspond to one or more RADAR frames 320, one or more LiDAR frames 322, and/or one or more video frames 324 and corresponding metadata. As indicated in FIGS. 1B and 1C, the input frames 306 may represent or include one or more frames of sensor data and/or inference results or data.

In at least one embodiment, the mixer(s) 308 merges LiDAR/RADAR and camera multi-frames into a single HashMap frame. In at least one embodiment, the mixer(s) 308 synchronizes different sensor information based at least on timeclock and frame timestamps to pair (e.g., combine, mix, etc.) frames from different sensors into a single synchronized frame. The mixer(s) 308 may, based at least on a policy(ies), drop one or more frames, make up one or more frames, and/or interpolate one or more frames, for example, to keep the pipeline operating smoothly (e.g., for rendering views according to a framerate).

In at least one embodiment, the mixer(s) 308 receives any sensor data and/or corresponding inference data, such as RADAR data, image data, LiDAR data, etc., from multiple sensor sources (e.g., from at least one 2D sensor source and at least one 3D sensor source). The mixer(s) 308 may pair the multi-sensor input together and compare timestamps for sensor synchronization to combine them into a single HashMap. The mixer(s) 308 may transmit this “mixed” HashMap data to downstream components, such as the aligner(s) 110. Based at least on policy settings, the mixer(s) 308 may perform one or more operations. For example, the mixer(s) 308 may drop some data if the sensor capture framerate is faster than other sensor sources. As another example, the mixer(s) 308 may make up data (e.g., copy or interpolate data) for low framerate sensor data input. As a further example, the mixer(s) 308 may smooth data to align with a specific framerate.

In at least one embodiment, a policy used by the mixer(s) 308 may be to drop one or more frames to align with a lowest framerate sensor data source. Another example of a policy used by the mixer(s) 308 may be to make up or otherwise generate one or more frames to align with a highest framerate sensor data source. A further example of a policy used by the mixer(s) 308 may be to smooth frames to align with one or more user specified framerates (e.g., which may include dropping and making up frames).

In at least one embodiment, the mixer(s) 308 is derived from a data mixer 304 interface element of the interface elements 104. The data mixer 304 may define a standardized contract for synchronizing and merging sensor-specific data into a unified data structure. For example, the data mixer 304 may provide a set of predefined methods and data structures that are responsible for data synchronization, data merging, temporal and spatial alignment, memory and resource management, and/or standardized interface operations. Data synchronization may include functions that align sensor inputs-such as video buffers, LiDAR point clouds, and associated metadata-based on time stamps or other temporal markers to ensure that data from multiple modalities or sources corresponds to the same or similar real-world events. Data merging may include functions that consolidate these aligned inputs into a single, coherent data map that encapsulates the integrated information from various sensor modalities. Memory and resource management may include functions that handle memory allocation, buffer management, and error handling during the process, thereby ensuring that the consolidated data is correctly formatted and available for subsequent processing stages. By conforming to the interface of the data mixer 304, the mixer(s) 308 is ensured to maintain interoperability with other components of the multi-modal perception pipeline.

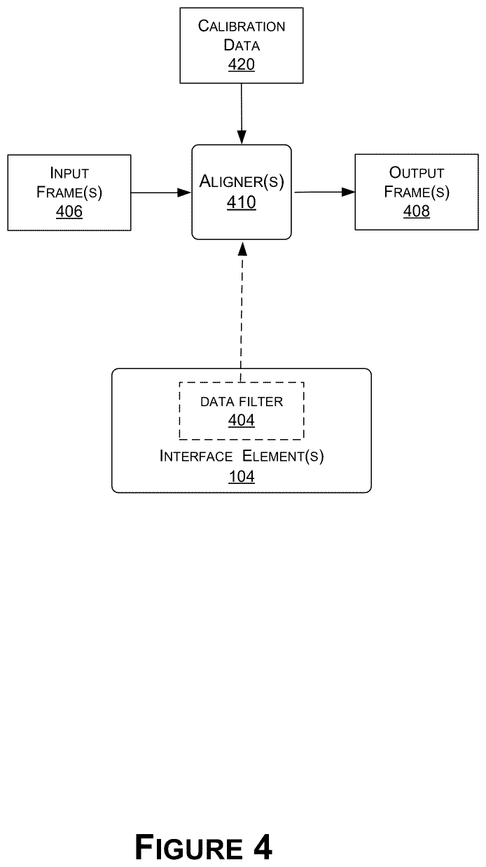

Referring now to FIG. 4, FIG. 4 illustrates an example of an aligner(s) 410 which may be instantiated in a multi-modal perception pipeline, in accordance with some embodiments of the present disclosure. In at least one embodiment, the aligner(s) 410 corresponds to the aligner (s) 110 in one or more of FIGS. 1A-1C.

The aligner(s) 410 may be configured to perform spatial and/or coordinate alignment on input data, such as one or more input frames 406 corresponding to multiple branches and/or sub-pipelines of a multi-modal perception pipeline (e.g., sensor data or corresponding inference results) to form output data, such as one or more output frames 408. As an example, the aligner(s) 410 may calibrate or otherwise align LiDAR data to video data using camera coordinates.

In at least one embodiment, the aligner(s) 410 receives calibration data 420 data (e.g., coordinates, which may be provided as part of or separately from configuration data) as input (e.g., from a file) to perform the spatial and/or coordinate alignment. For example, the aligner(s) 410 may use the calibration data 420 to perform sensor-to-sensor coordinate transformations in order to align one or more data points provided by the input frame(s) 406.

In at least one embodiment, the aligner(s) 410 is derived from a data filter 404 interface element of the interface elements 104. The data filter 404 defines a standardized contract for performing various data filtering operations, which may be used by various components including—but not limited to—the aligner(s) 410. For example, the data filter 404 provides a set of predefined methods and data structures responsible for general data filtering tasks, such as extracting and embedding key-value pairs and handling error management during data processing. These core filtering functions may be used to ensure that data corresponding to video buffers, LiDAR point clouds, associated pre-processing metadata, and/or other data is correctly formatted and available for subsequent stages. The aligner(s) 410 may add additional functions for spatial and coordinate transformation, which may use functions from the data filter 404. For example, the aligner(s) 410 may include functions for registering or aligning sensor inputs to a common reference frame using one or more custom extensions. These custom extensions may apply the spatial and coordinate transformations to align the data accurately, thereby facilitating precise overlay and/or subsequent analysis.

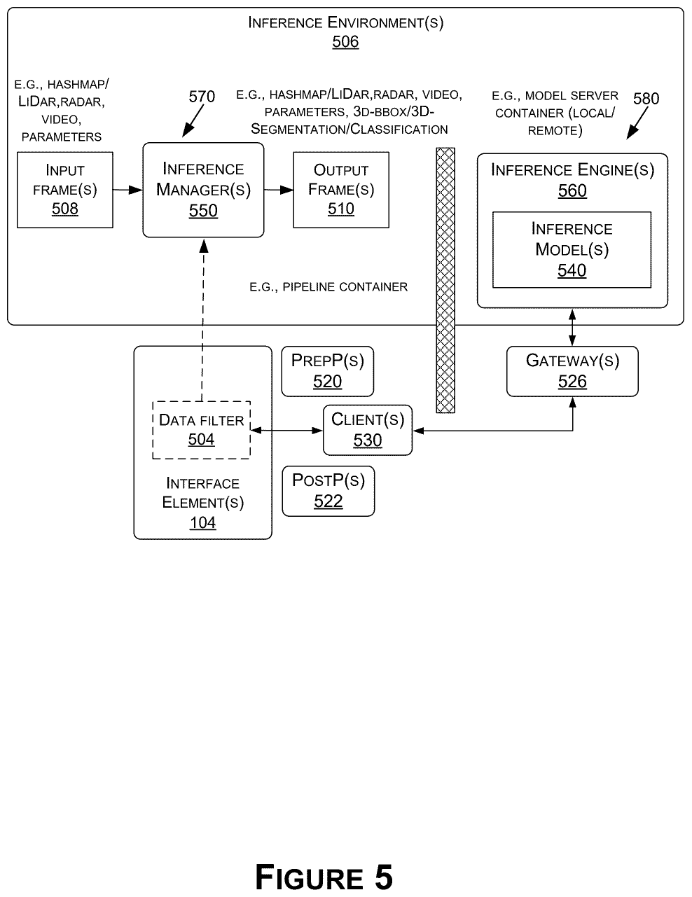

Referring now to FIG. 5, FIG. 5 illustrates an example of an inference environment(s) 506 which may be instantiated in a multi-modal perception pipeline, in accordance with some embodiments of the present disclosure. In at least one embodiment, the inference environment(s) 506 corresponds to the inference environment(s) 106, 106A, and/or 106B in one or more of FIGS. 1A-1C. The inference environment(s) 506 may include software and/or hardware for hosting and managing one or more inference models 540, where an inference engine 560 may be employed to execute the one or more inference models 540, transform input data, such as an input frame(s) 508 into output data, such as an output frame(s) 510 of actionable predictions and/or inference data, and orchestrate the overall inference workflow.

In at least one embodiment, the inference environment(s) 506 includes an inference manager(s) 550 to interface with an inference engine(s) 560 that hosts the inference models 540. For example, the inference manager(s) 550 may provide the input frame(s) 508 to the inference engine(s) 560, and the inference engine(s) 560 may apply the input frame(s) 508 to the inference model(s) to generate inference data, which may be provided to generate the corresponding output frame(s) 510.

In at least one embodiment, the inference environment(s) 506 may support different types of inference models 540 depending on the application, such as one or more of a 2D inference model(s) 540 (e.g., for video data), a 3D inference model(s) 540 (e.g., for LiDAR data), a mono-modal inference model(s) 540, or a multi-modal inference model(s) 540 for combining or fusing inputs from multiple sensor modalities.

The inference model(s) 540 may perform inferencing using one or more Machine Learning Models (MLMs). Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), vision-language-action (VLA) models, etc.), and/or other types of machine learning models.

In at least one embodiment, the inference manager(s) 550 is derived from a data filter 504 interface element of the interface elements 104, which establishes a standardized contract for data filtering operations. The data filter 504 may be similar to or different than the data filter 404 of FIG. 4. In at least one embodiment, the inference manager(s) extends the functionality of the data filter 504 by, for example, using one or more custom preprocessing routines 520 and/or postprocessing routines 522. The preprocessing routine(s) 520 may be used, for example, to normalize and/or convert the input frame(s) 508 (e.g., the unified data map or HashMap) into one or more tensor-based formats compatible with the inference model(s) 540. The postprocessing routine(s) 522 may be used, for example, to reformat the inference outputs into a standardized structure for further analysis or visualization.

By integrating with the inference engine(s) 560 that manages model execution—whether deployed locally or on remote servers using protocols such as HTTP or gRPC—the inference model(s) 540 may manage the inferencing workflow within the pipeline. For example, the inference model(s) 540 may ensures that inference requests are properly formatted, transmitted to the appropriate inference model(s) 540 (which may use acceleration technologies such as TensorRT), and that the resulting outputs are seamlessly passed to subsequent pipeline stages such as for visualization and/or further processing.

In at least one embodiment, the inference manager(s) 550, or the overall pipeline (e.g., other than the inference engine(s) 560) may correspond to a client-side 570 and one or more of the inference engines 560 may correspond to a server-side 580. For example, the inference manager(s) 550 may operate as a client(s) 530 of the inference engine(s) 560 via a gateway(s) 526. In at least one embodiment, the inference environment(s) 506 is built on a uniform inference interface—such as one based on a Cloud Function API—and support remote inference over HTTP, gRPC, or a different protocol. This configuration may allow the inference manager(s) 550, or the overall pipeline other than the inference engine(s) 560, to function as an API client of the inference engine(s) 560, thereby simplifying compute state management.

In at least one embodiment, the inference engine(s) 560 may be deployed on one or more servers (e.g., having powerful GPUs for inferencing) and/or within one or more local containers that are separate from other components of the pipeline. In at least one embodiment, the inference engine(s) 560 is deployed in one or more virtualized environments, such as a containerized environment that encapsulates one or more of the inference model(s) 540 along with at least one dependencies and configurations. As various examples, one or more NVCF model containers or Triton inference servers may be used to implement the inference engine(s) 560. Similarly, the inference manager(s) 550 and/or other components of the pipeline (e.g., other than the inference engine(s) 560) may be deployed on one or more local computers or other computing devices and/or within one or more virtualized and/or containerized environments (e.g., a container that is separate from the inferencing engine(s) 560).

In at least one embodiment, the inference manager(s) 550 requests inference data for the input frame(s) 508. For example, the inference manager(s) 550 may transmit an inference request and receive a response over HTTP/gRPC to access a specific model(s)—such as the BEVHeight model or the BEVFusion model. In some embodiments, an inference model(s) 540 may be hosted within an inference container that supports GPU-buffer-sharing (e.g., using CUDA-IPC) to reduce memory copying between the client 530 and the server. Additionally, the preprocessing routines 520 and/or the postprocessing routines 522 may be used to prepare input tensors and parse output tensors. For instance, during custom preprocessing, HashMap data may be normalized and transformed into a format digestible by the selected inference model(s) 540, while inference data may later be reformatted for compatibility with a multi-view renderer(s) 114, which displays different views of the sensor data (e.g., video and LiDAR).

In at least one embodiment, such as embodiments corresponding to FIG. 1B, the inference manager(s) 550 receives multi-modal data as input and may incorporate custom preprocessing and postprocessing functionalities. The renderer(s) 114 may subsequently generate one or more renderings including various sensor renderings (e.g., LiDAR/radar, and/or camera) based on the inference data provided by the inference engine(s) 560.

In at least one embodiment, such as embodiments corresponding to FIG. 1C, a 2D inference model may be used to perform inferencing on video data from one or more camera sources to produce 2D inference data, while a 3D inference model may be used to processes LiDAR data from one or more LiDAR sources to yield 3D inference data. For example, respective instances of the inference manager(s) 550 may may request respective inference data from one or more inference engines 560 operating on one or more remote cloud servers and/or one or more local machines. Optional custom preprocessing routines 520 and/or postprocessing routines 522 may be used as needed.

In at least one embodiment, the inference model(s) 540 receives multi-sensor data—such as LiDAR/radar, image data, and sensor parameters (intrinsic and/or extrinsic)—to generate inference outputs, such as 3D bounding boxes, 3D segmentation masks, 2D bounding boxes, 2D segmentation masks, and/or classification results. The inference manager(s) 550, operating as an API client, transmits an inference request to the inference model 540 and receives an inference response via RPC/IPC APIs. Examples of such APIs include HTTP REST function APIs (compatible with OpenAPI) and gRPC function APIs (transmitting data in protobuf format). For instance, a NVCF model container might use an HTTP REST function API, whereas a Triton inference server might be accessed via a gRPC function API. Custom preprocessing routines 520 and postprocessing routines 522 may also be defined for aligning the multi-modal input data with the specific input/output requirements of the inference model(s) 540. An inference server supporting the inference engine(s) 560 may be deployed remotely (e.g., in the cloud) or locally, depending on performance, latency, platform (e.g., Jetson/dGPU), compute capability, and model size. In some embodiments, a shared inference support buffer (e.g., using CPU-buffer sharing or CUDA-IPC for GPU) may be used in local deployments to reduce client container size and expedite pipeline startup, since model initialization mat occur on the server-side 580 and may take seconds to minutes.

In at least one embodiment, the API server may be implemented using NVCF model containers (e.g., AI playground), a Triton inference server (where a user sets up a multi-modal model via Triton backends), and/or another HTTP inference gateway (e.g., user-requested inference via OpenAI or Hugging Face). In cases where an inference model(s) 540 is user-trained and deployed, the user may set up the HTTP server independently or employ a Triton inference server to deploy their multi-modal inference model 540 (e.g., models based on PyTorch, Python, ONNX, TRT, or TRT-LLM).

With an API server in place, multi-modal inference models 540 of varying complexities can be accessed via APIs. In some embodiments, certain multi-modal inference models 540 comprise multiple interconnected sub-models—for example, a BEVFusion model might include a camera-backbone model, a LiDAR-backbone model, and a fusion-backbone model, such as what is shown in FIG. 7B. The API server may manage the interconnection of these sub-models, thereby abstracting the underlying complexity from the client 530.

In some embodiments, techniques such as GPU-CUDA-IPC and HOST-memory-buffer-sharing may be employed when the client 530 and the server (e.g., inference environment(s) 506) reside on the same machine (e.g., Orin with dGPU T4/4090). Additionally, remote video and LiDAR data may be compressed using lossy or lossless methods (e.g., JPEG, PNG, ZIP, BZ2) to improve network latency and throughput. This approach also may reduce pipeline startup latency by offloading model initialization to the server-side 580.

Referring now to FIG. 6, FIG. illustrates an example of a renderer(s) 614 which may be instantiated in a multi-modal perception pipeline, in accordance with some embodiments of the present disclosure. In at least one embodiment, the renderer(s) 614 corresponds to the renderer (s) 114 in one or more of FIGS. 1A-1C.

The renderer(s) 614 may be configured to generate renderings corresponding to inference results from the multi-modal perception pipeline, which may include multiple views corresponding to multiple sensor data sources with overlays. For example, the renderer(s) 614 may use output frame(s) 610 (e.g., inference results and metadata) to generate one or more corresponding rendered frames 612. In at least one embodiment, such as embodiments corresponding to FIG. 1B, the output frames 610 may include one or more of the output frames 510 (e.g., a HashMap or data map from the inference environment 106). In at least one embodiment, such as embodiments corresponding to FIG. 1C, the output frames 610 may include one or more of the output frames 408 (e.g., a HashMap or data map from the aligner 110).

In some embodiments, the renderer 614 provides a rendering(s) corresponding to multi-sensor data from the multiple sensors (e.g., corresponding to the data source(s) 132 and the data source(s) 134). In one or more embodiments, the renderer 614 is capable of supporting multiple, different views (e.g., single LiDAR/radar data displayed into a top view and front view together) for one or more sensors (e.g., each sensor and/or data source).

In at least one embodiment, the renderer(s) 614 is derived from a data output 604 (also referred to as “data renderer 604”) of the interface elements 104. The data output 604 may define a standardized contract for converting sensor-specific data into the unified data structure.

In at least one embodiment, the renderer(s) 614 is derived from a data renderer 604 of the interface elements 104. The data renderer 604 may define a standardized contract for converting unified data structures—generated by preceding sensor data conversion and/or inference stages—into visual output suitable for display or storage. For example, the data renderer 604 may provide a set of predefined methods and data structures responsible for formatting processed sensor data, such as tensor-based representations and detection results, into graphical displays such as annotated video frames or 3D visualizations. The data renderer 604 may provide formatting functions that extract unified data and convert the data into displayable buffers while embedding key-value pairs and contextual visualization metadata (e.g., annotation styles, color codes, and layout configurations) to ensure that all relevant sensor and inference information is visually preserved. The data renderer 604 may provide memory and resource management functions that handle allocation, graphical buffer management, and error handling during rendering of visual outputs. By conforming to the interface of the data renderer 604, the renderer(s) 614 maintain full interoperability with other components of the multi-modal perception pipeline, thus facilitating consistent and accurate visualization of the fused sensor data and inference outcomes.

In at least one embodiment, the data renderer 604 is configured to process the data output by the data filter 504 and/or the data filter 404 and, based on the processing, output additional data. For instance, the data renderer 604 may be configured to process 3D data, a HashMap, and/or 3D scene data and, based on the processing, output a rendered frame(s) 612 representing content (e.g., an image) depicting a 3D scene. In some examples, the content may include information associated with an object(s), such as a bounding shape indicating a location of the object (e.g., a vehicle). However, the rendered frame(s) 612 may include other types of data, such as data that is output to one or more systems of a vehicle for further processing.

In at least one embodiment, the renderer(s) 614 supports different data renderings, such as LiDAR/radar/image data renderings. Each source and/or type of sensor data could be rendered in different views (e.g., layouts). For example, single type and/or source of sensor data (e.g., LiDAR data) could be rendered in multiple views such as, but not limited to, top-view, side-view, and/or front-view. Transformation may be supported for respective view settings (e.g., view-point settings may determine the views). The renderer(s) 614 may apply intrinsic/extrinsic parameters (e.g., included in the calibration data 420) to project 3D bounding boxes and/or segmentation onto camera images.

Referring now to FIG. 7A, FIG. 7A depicts an example three-dimensional (3D) data processing pipeline 702, in accordance with some embodiments of the present disclosure. The processing pipeline 702 may include a number of components, such as four components in the example of FIG. 7A (although the processing pipeline 702 may include a different number of components in other examples). As described herein, one or more of the components may include plugin wrapper. For instance, and in the example of FIG. 7A, the first component may include a data source plugin 704, the second component may include a first data filter plugin 706, the third component may include a second data filter plugin 708, and the fourth component may include a data output plugin 731. However, in other examples, one or more of the components may include a different type of data processing plugin.

The data source plugin 704 may be configured to generate and/or receive data for processing by the data pipeline 702. In some examples, the data includes 2D input data 740, such as color data (e.g., 2D frames) and depth data (e.g., heatmap frames), and/or a HashMap 740 associated with the 2D input data 740. In some examples, the data is generated by one or more sources, such as a camera, a radar sensor, a LiDAR sensor, and/or any other type of sensor.

The first data filter plugin 706 may be configured to process the data output by the data source plugin 704 and, based on the processing, output additional data. For example, the first data filter plugin 706 may include a point cloud filter that is configured to process the 2D input data/HashMap 740 and, based on the processing, output 3D data 744 and/or HashMap data 744 associated with the 3D data 744. In some examples, the 3D data 744 may include point cloud data, such as point cloud frames corresponding to the 2D frames represented by the 2D input data 740.

The second data filter plugin 708 may be configured to process the data output by the first data filter plugin 706 and, based on the processing, output additional data. For example, the second data filter plugin 708 may include a 3D inference plugin that is configured to process the 3D data/HashMap 744 and, based on the processing, output 3D scene data 746. In some examples, the 3D scene data represents information associated an object(s) represented by the 2D input data (e.g., an object(s) located within the scene). For example, the 3D scene data may include, but is not limited to, data indicating a location(s) (e.g., a bounding shape(s)) of an object(s) within the scene, data indicating a classification(s) associated with the object(s), and/or data representing any other type of information associated with the object(s). As shown by the example depicted in FIG. 7A, the second data filter 708 may further output the 3D data 746 and/or a HashMap 746 associated with the object data 746 and/or the 3D data 746.

The data output plugin 731 may be configured to process the data output by the second data filter plugin 708 and, based on the processing, output additional data. For instance, and as depicted in the example of FIG. 7A, the data output plugin 731 may include a data renderer plugin that is configured to process the 3D data 746, the HashMap 746, and/or the 3D scene data 746 and, based on the processing, output data 751 representing content (e.g., an image) 752 depicting a 3D scene 754. In some examples, the content 752 may include information associated with an object(s), such as a bounding shape indicating a location 756 of an object (e.g., a vehicle). However, in other examples, the output data 751 may include other types of data, such as data that is output to one or more systems of a vehicle for further processing.

As further illustrated in the example of FIG. 7A, the processing pipeline 702 may use one or more data structures, such as one or more buffers, when performing the processing described herein. In some examples, one or more of the buffers may include a HashMap buffer that is used as a communication buffer between one or more of the components. In such examples, inside the HashMap buffer, data may be added, updated, and/or removed. Additionally, a unique name (e.g., a string or specific identifier) may be used as a hash-table key, the data (e.g., the structure or frames) may be stored as values, and a type identifier may be used to check to make sure that the data structure is verified, which is described in more detail below.

For example, a first data buffer(s) 758, which may include a first HashMap buffer in some examples, may store the 2D input data 740 and/or the HashMap 740 that is output by the data source plugin 704 and input into the first data filter plugin 706. The first data buffer(s) 758 may include a key, such as a unique name (e.g., a string or specific identifier), associated with the first data buffer(s) 758 and/or the stored data. Additionally, the first data buffer(s) 758 may include a type identifier that indicates the type of stored data, such as the type of 2D input data 740 (e.g., color data, depth data, etc.) in the example of FIG. 7A, and/or any other type of data in other examples. Furthermore, the first data buffer(s) 758 may include one or more values that are used to store the data, such as the 2D input data 740 (e.g., color frames, depth frames, etc.) in the example of FIG. 7A, although the value(s) may store other type of data in other examples. As described herein, the data source plugin 704 may use the first data buffer(s) 758 and/or the HashMap 740 to communicate with the first data filter plugin 706.

A second data buffer(s) 760, which may include a second HashMap buffer in some examples, may store the 3D data 744 and/or the HashMap 744 that is output by the first data filter plugin 706 and input into the second data filter plugin 708. The second data buffer(s) 760 may include a key, such as a unique name (e.g., a string or specific identifier), associated with the second data buffer(s) 760 and/or the stored data. Additionally, the second data buffer(s) 760 may include a type identifier that indicates the type of data, such as the 3D point data 744 and/or at least a portion of the 2D input data 740 in the example of FIG. 7A, and/or any other type of data in other examples. Furthermore, the second data buffer(s) 760 may include one or more values that are used to store the data, such as the color frames, the depth frames, and/or 3D point frames in the example of FIG. 7A, and/or any other type of data in other examples. As described herein, the first data filter plugin 706 may use the second data buffer(s) 760 and/or the HashMap 744 to communicate with the second data filter plugin 708.

A third data buffer(s) 762, which may include a third HashMap buffer in some examples, may store the 3D data 746, the HashMap 746, the 3D scene data 746 and/or additional data that is output by the second data filter plugin 708 and input into the data output plugin 731. The third data buffer(s) 762 may include a key, such as a unique name (e.g., a string or specific identifier), associated with the third data buffer(s) 762 and/o the stored data. Additionally, the third data buffer(s) 762 may include a type identifier that indicates the type of data, such as the 3D point data 746, the 3D scene data 746, and/or at least a portion of the 2D input data 740 in the example of FIG. 7A, and/or any other type of data in other examples. Furthermore, the third data buffer(s) 762 may include one or more values that are used to store the data, such as the color frames, the depth frames, 3D point frames, and/or the inference information in the example of FIG. 7A, and/or any other type of data in other examples. As described herein, the second data filter plugin 708 may use the third data buffer(s) 762 to communicate with the data output plugin 731.

While the example of FIG. 7A illustrates the data buffers 758, 760, and 762 as being separate from one another, in other examples, one or more of the data buffers 758, 760, or 762 may be combined. Additionally, while the example of FIG. 7A illustrates two different data filter plugins 706 and 708, in other examples, the processing pipeline 702 may include any number of data filter plugins and/or other data filter plugins or interface elements 104 to perform any type of data processing. For example, the first data filter plugin 706 and the second data filter plugin 708 may be combined into a single plugin that performs the processes described herein with respect to both the first data filter plugin 706 and the second data filter plugin 708. Further, any of the other components, plugins, and/or interface elements 104 described herein may operate and communicate in a pipeline in a similar manner as described with respect to FIG. 7A.

While the example of FIG. 7A is directed to a 3D data processing pipeline that performs 3D processing, in some embodiments, a 3D processing pipeline may be coupled with a 2D data processing pipeline, such as a 2D multimedia pipeline. For instance, FIG. 7B illustrates an example of implementing a 3D data processing pipeline with a conventional 2D multimedia pipeline. As shown, the processing pipeline 702 may include one or more components associated with a 2D multimedia pipeline 702A, which are illustrated as being within a first dashed box, and one or more components associated with a 3D data processing pipeline 702B, which are illustrated as being within a second dashed box.

In the example of FIG. 7B, the 2D multimedia pipeline 702A may generate and/or receive video data 764(1)-(2). In some examples, the video data 764 is generated by and/or received from a single source, such as a single camera. In other examples, the video data 764 is generated by and/or received from multiple sources, such as multiple cameras. The 2D multimedia pipeline 702A may then perform batching 766 on the video data 764, such as by using a component of the 2D multimedia pipeline 702A. In some examples, the video data 764 may be processed before the batching 766, such as by using a decoder(s) to generate raw video data 764.

The 3D data processing pipeline 702B may then include a first component, such as a first data filter 770 (e.g., a HashMap converter), that is configured to process the batched video data 764 and generate a data structure, such as a HashMap 772. The 3D data processing pipeline 702B may further include one or more additional data filters 774 for processing the images and/or the HashMap 772. For instance, in some examples, the additional data filter(s) 774 may include the first data filter plugin 706 and/or the second data filter plugin 708. Based on processing the images and/or the HashMap 772, the additional data filter(s) 774 may generate and output 3D point data and/or a HashMap 776. The 3D data processing pipeline 702B may then include a data output component 778 that is configured to generate output data using the output 3D point data and/or the HashMap 776. In some examples, the output data is similar to the output data 751.

Referring now to FIG. 7C, FIG. 7C is a data flow diagram illustrating an example of a multi-modal perception pipeline 730 that incorporates LiDAR and camera data in a multi-modal perception system, in accordance with some embodiments of the present disclosure. The multi-modal perception pipeline 730 may be an example of the multi-modal perception pipeline 130A of FIG. 1B.

The multi-modal perception pipeline 730 of FIG. 7C includes a LiDAR data source 734 and any number of camera or video data sources 732A, and 732B through 732N (732A-732N), one or more of which may be derived from a data source 704 (or data loader) interface element 104. The data source 704 may provide routines for ingesting raw sensor data from various sources such as cameras, depth sensors, and/or LiDAR devices. In some cases, the data source 704 may provide routines or functions that convert sensor-specific inputs into a unified data structure (a data map) that includes both the raw data and associated metadata such as timestamps and sensor parameters.

A mux 750, for example, a stream mux, may be used for synchronizing and batching data streams from multiple sensors, such as the cameras 732A-732N. In at least one embodiment, the mux 750 collects individual frames via dedicated sink pads and forms a batched buffer based on a specified batch size. If the incoming frames differ in resolution, the mux 750 may scale them to a same and/or user-defined width and height, optionally preserving the original aspect ratio through padding. The mux 750 may use a round-robin algorithm to evenly gather frames from each source, pushing the batch downstream either when the batch is full or when a configured timeout elapses. In at least one embodiment, the mux 750 attaches a metadata structure to each batched buffer—capturing information such as the source ID, original frame resolutions, and timestamps—to facilitate precise downstream processing. The mux 750 may also support dynamic addition or deletion of sources at runtime and offer flexible memory and timestamp management (including NTP timestamps), thereby ensuring that multi-modal sensor data is uniformly formatted and temporally aligned for efficient fusion and inference in the pipeline 730.

The example of FIG. 7C may correspond to a bird's-eye view fusion (BEVFusion) perception pipeline 730 created using the configuration data 120 as input to a multi-modal perception fusion application that includes the pipeline manager 102. The example of FIG. 7C indicates six 2D sensor sources and one 3D sensor source, which is not intended to be limiting. For example, any number/type of 2D sensor sources and any number/types of 3D sensor sources may be used.

In at least one embodiment, the pipeline 730 is dynamically configured by providing a single graph-based schema configuration file (e.g., bev_fusion.yaml) to the multi-modal perception fusion application.

As described herein, one or more of the components of the pipeline 730 may correspond to a plugin wrapper. For instance, and in the example of FIG. 7C, the interface elements 104 may comprise data processing plugins. However, in other examples, one or more of the components may include a different type of data processing plugin.

The data source 704 may be configured to generate and/or receive for processing by the pipeline 730. In some examples, the data includes 2D input data, such as color data (e.g., 2D frames) and depth data (e.g., heatmap frames), and/or a HashMap associated with the 2D input data. In some examples, the data is generated by one or more sources, such as a camera, a radar sensor, a LiDAR sensor, and/or any other type of sensor.

Referring now to FIG. 7D, FIG. 7D is a data flow diagram illustrating an example of at least one multi-modal model 740 that may be used in the multi-modal perception pipeline of FIG. 7C, in accordance with some embodiments of the present disclosure. In particular, the multi-modal model(s) 740 may correspond to the inference model(s) 540. By way of example, and not limitation, the multi-modal models 740 may incorporate five models in a BEVFusion model backbone. For example, the multi-modal model(s) 740 may include a video encoder model 710, a camera to BEV transformer model 712, a LiDAR encoder model 714, a BEV encoder fusion model 716, and an object detection model 718 to determine inference data 720 (e.g., indicating bounding shapes of one or more objects) from video data 722 corresponding to the video data sources 732A-732N and LiDAR data 724 corresponding to the LiDAR data source 704. Present techniques may advantageously simplify multi-modal perception fusion pipelines, wherein the API functionality of the inference manager 550 makes calls to an API server(s) hosting the models 740. In this manner, since the API server may connect backbone models together, and the client 530 does not need to handle the complexity of the models 740.

Referring now to FIG. 7E, FIG. 7E illustrates an example of a frame 780 that may be rendered using the multi-modal perception pipeline 730 of FIG. 7C, in accordance with some embodiments of the present disclosure. For example, the frame 780 may correspond to a rendered frame 612 of FIG. 6. In this example, the frame 780 displays six cameras in six different views (top row and bottom row of the rendered result). The top row shows different front views of a vehicle (e.g., autonomous vehicle 1000 of FIG. 10A), such as front-left, front, and front-right views. The bottom row shows the rear views of the vehicle, such as rear-left, rear, and rear-right views. In this example, one single LiDAR data source 704 is rendered in two different views (middle row of the rendered result). The two different views include a top view and front view. As shown in FIG. 7E, 3D bounding boxes or shapes (e.g., a bounding shape 790) from the 3D inference result are displayed in all the views, with other intrinsic/extrinsic parameters. For example, the 3D bounding boxes projected into each camera's views (see top and bottom rows). The 3D bounding boxes are also displayed in the top view and front views (see middle row).

Below is an example of a portion of an example YAML configuration file for rendering multiple views:

```
# render view config body
  config_body:
    - 2d_view: # image view
      camera0: ...
      camera1: ...
      camera2: ...
      camera3: ...
    - 3d_top_view: # lidar top view
      lidar_input: lidar_hash_name
    - 3d_front_view: # lidar front view
      lidar_input: lidar_hash_name
```

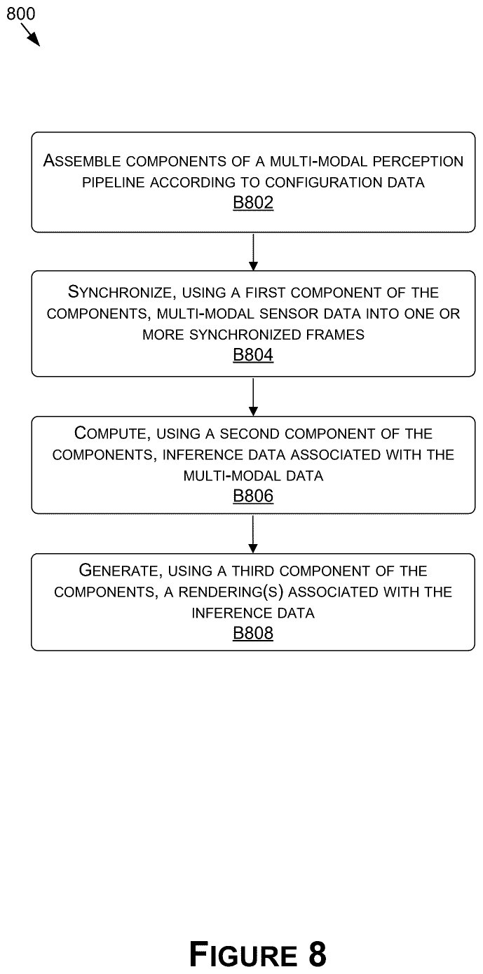

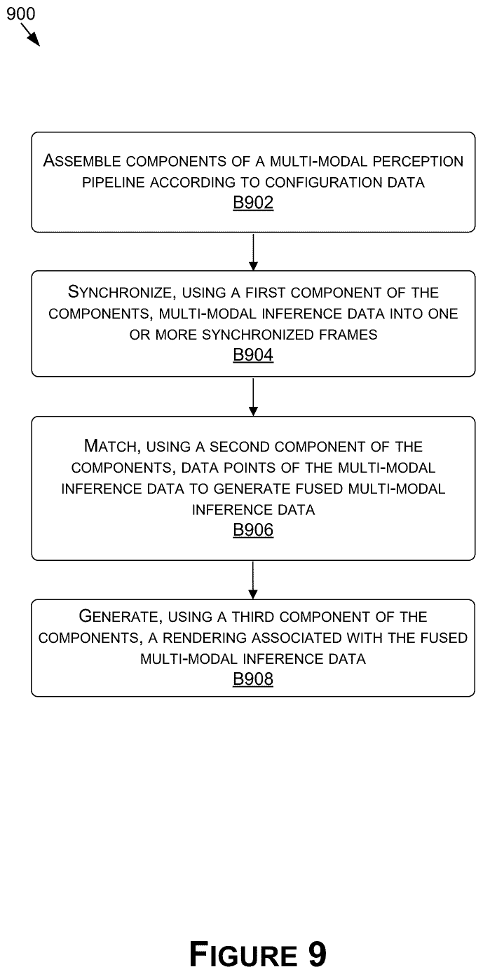

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, the methods 800 and 900 are described, by way of example, with respect to FIGS. 1A-1C. However, these methods 800 and 900 may additionally or alternatively be executed by any one system, or any combination of systems, including, but not limited to, those described herein.

FIG. 8 is a flow diagram showing a method 800 for processing data using a multi-modal perception pipeline having at least one multi-modal inference model, in accordance with some embodiments of the present disclosure. The method 800, at block B802, may include assembling components of a multi-modal perception pipeline according to configuration data. For example, the pipeline manager 102 may assemble components of the multi-modal perception pipeline 130A according to the configuration data 120 that identifies the components.

The method 800, at block B804, may include synchronizing, using a first component of the components, multi-modal sensor data into one or more synchronized frames. For example, the pipeline manager 102 may use the mixer(s) 108 to synchronize first sensor data corresponding to a first sensor modality (e.g., corresponding to the data source(s) 132) and second sensor data corresponding to a second sensor modality (e.g., corresponding to the data source(s) 134) into one or more synchronized frames, such as a synchronized frame(s) 340 of FIG. 3.

The method 800, at block B806, may include computing, using a second component of the components, inference data associated with the multi-modal data. For example, the pipeline manager 102 may use the inference environment(s) 106 processing the one or more synchronized frames to compute inference data (e.g., an output frame(s) 510 of FIG. 5) indicating 3D information associated with the first sensor data and the second sensor data.

The method 800, at block B808, may include generating, using a third component of the components, a rendering associated with the inference data. For example, the pipeline manager 102 may use the renderer(s) 114 and the 3D information to generate a rendering (e.g., a rendered frame(s) 612 of FIG. 6) including multiple views associated with the first sensor modality and the second sensor modality.

FIG. 9 is a flow diagram showing a method 900 for processing data using a multi-modal perception pipeline that includes late fusion of multi-modal inference data, in accordance with some embodiments of the present disclosure. The method 900, at block B902, may include assembling components of a multi-modal perception pipeline according to configuration data. For example, the pipeline manager 102 may assemble components of the multi-modal perception pipeline 130B according to the configuration data 120 that identifies the components.

The method 900, at block B904, may include synchronizing, using a first component of the components, multi-modal inference data into one or more synchronized frames. For example, the pipeline manager 102 may use the mixer(s) 108 to synchronize first inference data (e.g., generated using the inference environment(s) 106A) corresponding to a first sensor modality (e.g., corresponding to the data source(s) 132) and second inference data (e.g., generated using the inference environment(s) 106B) corresponding to a second sensor modality (e.g., corresponding to the data source(s) 134) into one or more synchronized frames, such as a synchronized frame(s) 340 of FIG. 3.

The method 900, at block B906, may include matching, using a second component of the components, data points of the multi-modal inference data to generate fused multi-modal inference data. For example, the pipeline manager 102 may use the aligner(s) 110 and the one or more synchronized fames to match, first data points corresponding to the first inference data with second data points corresponding to the second inference data to generate 3D information (e.g., included in the output frame(s) 408 of FIG. 4) corresponding to the first data points fused with the second data points.

The method 900, at block B908, may include generating, using a third component of the components, a rendering associated with the fused multi-modal inference data. For example, the pipeline manager 102 may use the renderer(s) 114 and the 3D information to generate a rendering (e.g., a rendered frame(s) 612 of FIG. 6) including multiple views associated with the first sensor modality and the second sensor modality.

In some embodiments, the systems and methods described herein may be performed within a simulation environment (e.g., NVIDIA's DriveSIM, NVIDIA's ISAAC GYM, NVIDIA's ISAAC SIM, etc.) using simulated data (e.g., simulated sensor data of simulated sensors of a virtual or simulated machine). For example, simulated sensor data may be used (e.g., processed using one or more machine learning models, neural networks, etc.) to identify, detect, and/or classify lane lines, road boundary lines, other lines, vertical structures/features, etc. within the simulation environment using points of a curve and/or one or more curve fitting algorithms, and may use this information to perform operations (e.g., control, navigation, planning, etc. operations) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications. In at least one embodiment, the simulation data may be used as a data source(s) to a pipeline 130a and/or 130B or other pipeline described herein and/or may be generated by or using the pipeline.

In some embodiments, teleoperation or remote control of a vehicle or other machine may be performed using a remote control or teleoperation system. For example, the systems and methods described herein may be used to identify lane lines, road boundary lines, longitudinal features, etc. that may be included in a visualization or mapping of an environment to aid a remote operator in controlling—or providing waypoints or other indications of control or navigation—an autonomous or semi-autonomous machine through an environment. For example, the output corresponding an inference environment(s) 106 may be used to control the machine.

In some examples, the machine learning model(s) (e.g., deep neural networks, language models, LLMs, SLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. In at least one embodiment, an inferencing environment(s) 106 may include at least one NIM.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, SLM, VLM, MMLM, diffusion model, transformer model, NeRF, DNN, etc.) and/or the image database hosted on the local and/or remote servers using one or more APIs—such as, without limitation, REST APIs. In at least one embodiment, the render(s) 114 may render voice data (e.g., for a kiosk) in addition to or alternatively from image data.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use the one or more machine learning models (e.g., diffusion models, transformer models, neural rendering field (NeRF) models, language models (e.g., LLMs, SLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. For example, the client device may correspond to a client 530 interacting with the inference engine(s) 560.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, SLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), small language models (SLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, SLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. For example, a rendered frame 612 may be displayed using the IVI system or IX application.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 0C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

1. A computer-implemented method comprising: assembling components of a multi-modal perception pipeline according to configuration data that identifies the components; synchronizing, using a first component of the components, first sensor data corresponding to a first sensor modality and second sensor data corresponding to a second sensor modality into one or more synchronized frames; computing, using one or more multi-modal inference models of a second component of the components processing the one or more synchronized frames, inference data indicating 3D information associated with the first sensor data and the second sensor data; and generating, using a third component of the components and the 3D information, a rendering including multiple views associated with the first sensor modality and the second sensor modality.

2. The computer-implemented method of 1, further comprising matching, using a fourth component of the components and calibration data associated with the first sensor data and the second sensor data, first data points corresponding to the first sensor data with second data points corresponding to the second sensor data to align the first sensor data with the second sensor data in the one or more synchronized frames, and the computing of the inference data is based at least on the matching.

3. The computer-implemented method of any of 1-2, wherein the first component is derived, at least in part, from a first interface element of a multi-modal sensor fusion framework, the first interface element providing a set of predefined synchronization methods and data structures used to perform the synchronizing.

4. The computer-implemented method of any of 1-3, wherein the second component includes an Application Programming Interface (API) client of an API server that hosts the one or more multi-modal inference models.

5. The computer-implemented method of any of 1-4, wherein the configuration data is a graph-based schema configuration file that identifies the components and interconnection specifications corresponding to two or more components of the components.

6. The computer-implemented method of any of 1-5, further comprising converting, using a fourth component of the components, the first sensor data into a unified data structure format that is shared with the second sensor data, wherein the synchronizing is performed on the first sensor data and the second sensor data in the unified data structure format.

7. The computer-implemented method of any of 1-6, wherein the first component, using one or more policies and a target framerate to generate the one or more synchronized frames, performs one or more of dropping or interpolating one or more frames corresponding to the first sensor data.

8. The computer-implemented method of any of 1-7, wherein the one or more synchronized frames include a HashMap storing key-value pairs representing the first sensor data and the second sensor data.

9. The computer-implemented method of any of 1-8, wherein the rendering includes first representations of 3D bounding shapes overlaid on one or more first frames corresponding to the first sensor data and second representations of the 3D bounding shapes overlaid on one or more second frames corresponding to the second sensor data.

10. A system comprising: one or more processors to perform operations including: assembling components of a multi-modal perception pipeline according to configuration data that identifies the components; synchronizing, using a first component of the components, first inference data corresponding to a first sensor modality and second inference data corresponding to a second sensor modality into one or more synchronized frames; matching, using a second component of the components and the one or more synchronized fames, first data points corresponding to the first inference data with second data points corresponding to the second inference data to generate 3D information corresponding to the first data points fused with the second data points; and generating, using a third component of the components and the 3D information, a rendering including multiple views associated with the first sensor modality and the second sensor modality.

11. The system of 10, wherein the first component is derived, at least in part, from a first interface element of a multi-modal sensor fusion framework, the first interface element providing a set of predefined synchronization methods and data structures used to perform the synchronizing.

12. The system of any of 10-11, wherein the operations further include computing the first inference data using one or more first inference models of one or more fourth components of the components processing first sensor data, and the second inference data using one or more second inference models of the one or more fourth components processing second sensor data.

13. The system of any of 10-12, wherein the configuration data is a graph-based schema configuration file that identifies the components and interconnection specifications corresponding to two or more components of the components.

14. The system of any of 10-13, wherein the operations further include converting, using a fourth component of the components, the first inference data into a unified data structure format that is shared with the second inference data, wherein the synchronizing is performed on the first inference data and the second inference data in the unified data structure format.

15. The system of any of 10-14, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model (LLM); a system for performing operations using a small language model (SLM); a system for performing operations using a vision language model (VLM); a system for performing operations using a multi modal language model (MMLM); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

16. At least one processor comprising: one or more circuits to assemble components of a multi-modal perception pipeline according to configuration data that identifies the components, the multi-modal perception pipeline to: synchronize, using a first component of the components, first sensor data corresponding to a first sensor modality and second sensor data corresponding to a second sensor modality into one or more synchronized frames; compute, using one or more multi-modal inference models of a second component of the components processing the one or more synchronized frames, inference data indicating 3D information associated with the first sensor data and the second sensor data; and generate, using a third component of the components and the 3D information, a rendering including multiple views associated with the first sensor modality and the second sensor modality.

17. The at least one processor of 16, wherein the multi-modal perception pipeline is further to match, using a fourth component of the components and calibration data associated with the first sensor data and the second sensor data, first data points corresponding to the first sensor data with second data points corresponding to the second sensor data to align the first sensor data with the second sensor data in the one or more synchronized frames, and the computing of the inference data is based at least on the matching.

18. The at least one processor of any of 16-17, wherein the first component is derived, at least in part, from a first interface element of a multi-modal sensor fusion framework, the first interface element providing a set of predefined synchronization methods and data structures used to perform the synchronizing.

19. The at least one processor of any of 16-18, wherein the second component includes an Application Programming Interface (API) client of an API server that hosts the one or more multi-modal inference models.

20. The at least one processor of any of 16-18, wherein the at least one processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model (LLM); a system for performing operations using a small language model (SLM); a system for performing operations using a vision language model (VLM); a system for performing operations using a multi-modal language model (MMLM); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A computer-implemented method comprising:
assembling components of a multi-modal perception pipeline according to configuration data that identifies the components;
synchronizing, using a first component of the components, first sensor data corresponding to a first sensor modality and second sensor data corresponding to a second sensor modality into one or more synchronized frames;
computing, using one or more multi-modal inference models of a second component of the components processing the one or more synchronized frames, inference data indicating 3D information associated with the first sensor data and the second sensor data; and
generating, using a third component of the components and the 3D information, a rendering including multiple views associated with the first sensor modality and the second sensor modality.

2. The computer-implemented method of claim 1, further comprising matching, using a fourth component of the components and calibration data associated with the first sensor data and the second sensor data, first data points corresponding to the first sensor data with second data points corresponding to the second sensor data to align the first sensor data with the second sensor data in the one or more synchronized frames, and the computing of the inference data is based at least on the matching.

3. The computer-implemented method of claim 1, wherein the first component is derived, at least in part, from a first interface element of a multi-modal sensor fusion framework, the first interface element providing a set of predefined synchronization methods and data structures used to perform the synchronizing.

4. The computer-implemented method of claim 1, wherein the second component includes an Application Programming Interface (API) client of an API server that hosts the one or more multi-modal inference models.

5. The computer-implemented method of claim 1, wherein the configuration data is a graph-based schema configuration file that identifies the components and interconnection specifications corresponding to two or more components of the components.

6. The computer-implemented method of claim 1, further comprising converting, using a fourth component of the components, the first sensor data into a unified data structure format that is shared with the second sensor data, wherein the synchronizing is performed on the first sensor data and the second sensor data in the unified data structure format.

7. The computer-implemented method of claim 1, wherein the first component, using one or more policies and a target framerate to generate the one or more synchronized frames, performs one or more of dropping or interpolating one or more frames corresponding to the first sensor data.

8. The computer-implemented method of claim 1, wherein the one or more synchronized frames include a HashMap storing key-value pairs representing the first sensor data and the second sensor data.

9. The computer-implemented method of claim 1, wherein the rendering includes first representations of 3D bounding shapes overlaid on one or more first frames corresponding to the first sensor data and second representations of the 3D bounding shapes overlaid on one or more second frames corresponding to the second sensor data.

10. A system comprising:
one or more processors to perform operations including:
assembling components of a multi-modal perception pipeline according to configuration data that identifies the components;
synchronizing, using a first component of the components, first inference data corresponding to a first sensor modality and second inference data corresponding to a second sensor modality into one or more synchronized frames;
matching, using a second component of the components and the one or more synchronized fames, first data points corresponding to the first inference data with second data points corresponding to the second inference data to generate 3D information corresponding to the first data points fused with the second data points; and
generating, using a third component of the components and the 3D information, a rendering including multiple views associated with the first sensor modality and the second sensor modality.

11. The system of claim 10, wherein the first component is derived, at least in part, from a first interface element of a multi-modal sensor fusion framework, the first interface element providing a set of predefined synchronization methods and data structures used to perform the synchronizing.

12. The system of claim 10, wherein the operations further include computing the first inference data using one or more first inference models of one or more fourth components of the components processing first sensor data, and the second inference data using one or more second inference models of the one or more fourth components processing second sensor data.

13. The system of claim 10, wherein the configuration data is a graph-based schema configuration file that identifies the components and interconnection specifications corresponding to two or more components of the components.

14. The system of claim 10, wherein the operations further include converting, using a fourth component of the components, the first inference data into a unified data structure format that is shared with the second inference data, wherein the synchronizing is performed on the first inference data and the second inference data in the unified data structure format.

15. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model (LLM);
a system for performing operations using a small language model (SLM);
a system for performing operations using a vision language model (VLM);
a system for performing operations using a multimodal language model (MMLM);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

16. At least one processor comprising:
one or more circuits to assemble components of a multi-modal perception pipeline according to configuration data that identifies the components, the multi-modal perception pipeline to:
synchronize, using a first component of the components, first sensor data corresponding to a first sensor modality and second sensor data corresponding to a second sensor modality into one or more synchronized frames;
compute, using one or more multi-modal inference models of a second component of the components processing the one or more synchronized frames, inference data indicating 3D information associated with the first sensor data and the second sensor data; and
generate, using a third component of the components and the 3D information, a rendering including multiple views associated with the first sensor modality and the second sensor modality.

17. The at least one processor of claim 16, wherein the multi-modal perception pipeline is further to match, using a fourth component of the components and calibration data associated with the first sensor data and the second sensor data, first data points corresponding to the first sensor data with second data points corresponding to the second sensor data to align the first sensor data with the second sensor data in the one or more synchronized frames, and the computing of the inference data is based at least on the matching.

18. The at least one processor of claim 16, wherein the first component is derived, at least in part, from a first interface element of a multi-modal sensor fusion framework, the first interface element providing a set of predefined synchronization methods and data structures used to perform the synchronizing.

19. The at least one processor of claim 16, wherein the second component includes an Application Programming Interface (API) client of an API server that hosts the one or more multi-modal inference models.

20. The at least one processor of claim 16, wherein the at least one processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model (LLM);
a system for performing operations using a small language model (SLM);
a system for performing operations using a vision language model (VLM);
a system for performing operations using a multimodal language model (MMLM);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
